(19) United States
(12) Patent Application Publication
(10) Pub. No.: US 2018/0219428 A1
(43) Pub. Date: Aug. 2, 2018

(54) METHOD AND APPARATUS FOR IDENTIFYING WIRELESS POWER RECEIVER

(71) Applicant: LG INNOTEK CO., LTD., Seoul (KR)

(72) Inventor: Su Ho BAE, Seoul (KR)

(73) Assignee: LG INNOTEK CO., LTD., Seoul (KR)

(21) Appl. No.: 15/741,682

(22) PCT Filed: Jun. 24, 2016
(86) PCT No.: PCT/KR2016/006767

§ 371 Date: Jan. 3, 2018

(30) Foreign Application Priority Data
Jul. 27, 2015 (KR) 10-2015-0105666
Aug. 3, 2015 (KR) 10-2015-0109595

(51) Int. Cl. H02J 50/60; H02J 50/12; H02J 7/02; H02J 50/90

(52) U.S. Cl. CPC H02J 50/60; H02J 50/90; H02J 7/025; H02J 50/12

(57) ABSTRACT

The present invention relates to a method for identifying a wireless power receiver, and apparatuses therefor. The method for identifying a wireless power receiver in a wireless power transmitter may comprise the steps of: detecting an object in a charging area; calculating the amount of impedance variation according to a change in transmission power when the object is detected; and determining, on the basis of the amount of impedance variation, whether or not the object is a normal receiver. Accordingly, the present invention has the advantage of being able to identify a normal receiver even in situations where the communication connection between the wireless power transmitter and the wireless power receiver is not normal.

### TECHNICAL FIELD

Embodiments relate to wireless charging technology, and more particularly, to a method and apparatus for identifying a wireless power receiver by a wireless power transmitter capable of identifying the wireless power transmission device capable of receiving wireless power and adaptively transmitting power according to the type of the identified wireless power reception device, even in a situation where communication between a wireless power transmission apparatus and a wireless power reception apparatus is not possible.

### BACKGROUND ART

Recently, as information and communication technology rapidly develops, a ubiquitous society based on information and communication technology is being formed.

In order for information communication devices to be connected anywhere and anytime, sensors equipped with a computer chip having a communication function should be installed in all facilities throughout society. Accordingly, power supply to these devices or sensors is becoming a new challenge. In addition, as the types of mobile devices such as Bluetooth handsets and iPods, as well as mobile phones, rapidly increase in number, charging the battery has required time and effort. As a way to address this issue, wireless power transmission technology has recently drawn attention.

Wireless power transmission (or wireless energy transfer) is a technology for wirelessly transmitting electric energy from a transmitter to a receiver using the induction principle of a magnetic field. Back in the 1800s, an electric motor or a transformer based on the electromagnetic induction principle began to be used. Thereafter, a method of transmitting electric energy by radiating an electromagnetic wave such as a radio wave or laser was tried. Electric toothbrushes and some wireless shavers are charged through electromagnetic induction.

Up to now, wireless energy transmission schemes may be broadly classified into electromagnetic induction, electromagnetic resonance, and RF transmission using a short-wavelength radio frequency.

In the electromagnetic induction scheme, when two coils are arranged adjacent to each other and current is applied to one of the coils, a magnetic flux generated at this time generates electromotive force in the other coil. This technology is being rapidly commercialized mainly for small devices such as mobile phones. In the electromagnetic induction scheme, power of up to several hundred kilowatts (kW) may be transmitted with high efficiency, but the maximum transmission distance is less than or equal to 1 cm. As a result, the device should be generally arranged adjacent to the charger or the floor.

The electromagnetic resonance scheme uses an electric field or a magnetic field instead of using an electromagnetic wave or current. The electromagnetic resonance scheme is advantageous in that the scheme is safe to other electronic devices or the human body since it is hardly influenced by the electromagnetic wave. However, this scheme may be used only at a limited distance and in a limited space, and has somewhat low energy transfer efficiency.

The short-wavelength wireless power transmission scheme (simply, RF transmission scheme) takes advantage of the fact that energy can be transmitted and received directly in the form of radio waves. This technology is an RF power transmission scheme using a rectenna. A rectenna, which is a compound of antenna and rectifier, refers to a device that converts RF power directly into direct current (DC) power. That is, the RF method is a technology for converting AC radio waves into DC waves. Recently, with improvement in efficiency, commercialization of RF technology has been actively researched.

The wireless power transmission technology is applicable to various industries including IT, railroads, and home appliance industries as well as the mobile industry.

Conventionally, in order to identify a reception apparatus capable of receiving wireless power, a wireless power transmission apparatus is required to exchange state information and characteristics information over an in-band communication channel or an out-of-band communication channel.

However, when there is no available communication channel between the wireless power transmission apparatus and the wireless power reception apparatus or communication is impossible, it is impossible to exchange the state intonation and characteristics information between the wireless power transmission apparatus and the wireless power reception apparatus, and accordingly the wireless power transmission apparatus cannot identify a receiver capable of receiving wireless power.

In addition, in conventional cases, the wireless power transmission apparatus initiates transmission of wireless power to the wireless power reception apparatus only after authentication as well as the operation related to the characteristics and state of the wireless power reception apparatus is completed. As a result, the start time of power transmission is delayed.

### DISCLOSURE

### Technical Problem

Therefore, the present disclosure has been made in view of the above problems, and embodiments provide a method for identifying a wireless power receiver and apparatus(es) therefor.

Embodiments also provide a method and apparatus for identifying a wireless power receiver which are capable of identifying a normal receiver capable of receiving wireless power even when communication between a wireless power transmission apparatus and a wireless power reception apparatus is impossible.

Embodiments also provide a method for identifying a wireless power reception apparatus, which is capable of identifying a receiver capable of receiving wireless power based on change in impedance and/or the amount of change in impedance according to change in transmit power intensity, and an apparatus therefor.

The technical objects that can be achieved through the embodiments are not limited to what has been particularly described hereinabove and other technical objects not described herein will be more clearly understood by persons skilled in the art from the following detailed description.

### Technical Solution

The present disclosure may provide a method for identifying a wireless power receiver, and an apparatus therefor.

In one embodiment, a method for identifying a wireless power receiver by a wireless power transmitter may include sensing an object in a charging area, calculating an impedance change amount according to change in transmit power intensity when the object in the charging area is sensed, determining whether the object is a normal receiver based on the impedance change amount, and when it is determined that the object is a normal receiver, starting transmission of wireless power to the normal receiver.

The calculating of the impedance change amount may include calculating a first impedance corresponding to a first transmit power intensity, calculating a second impedance corresponding to a second transmit power intensity, and calculating a difference between the first impedance and the second impedance.

The first transmit power intensity and the second transmit power intensity may be set based on at least one of an operating voltage of the normal receiver, a class of the wireless power transmitter, a category of the wireless power receiver supportable according to the class of the wireless power transmitter, or a degree of change in intensity of a magnetic field corresponding to a periodic power signal for sensing the object in the charging area.

When the impedance change amount exceeds a predetermined reference value, it may be determined that the sensed object is the normal receiver.

Here, the wireless power receiver identification method may further include transmitting power at a predefined intensity corresponding to the identified type.

The method may further include indicating that a foreign object (FO) has been sensed when it is determined that the sensed object is not the normal receiver.

The method according to claim 1, wherein the sensing of the object in the charging area includes transmitting a periodic power signal for sensing the wireless power receiver, sensing change in the transmitted power signal, sensing change in intensity of the magnetic field corresponding to the transmitted periodic power signal, and sensing whether the object is placed in the charging area according to the sensed change in intensity of the magnetic field.

The periodic power signal may include at least one of a ping signal or a beacon signal.

The wireless power receiver identification method may further include attempting to establish a communication connection with the object after the object is sensed, wherein, when the communication connection fails, the calculating of the impedance change amount according to the change in transmit power intensity may be performed.

In another embodiment, a method for identifying a wireless power receiver by a wireless power transmitter, the method may include sensing an object in a charging area, calculating an impedance change amount according to change in transmit power intensity when the object in the charging area is sensed, determining whether the object is a normal receiver based on the impedance change amount, and when it is determined that the object is the normal receiver, starting transmission of wireless power to the normal receiver.

The calculating of the impedance change amount may include calculating a first impedance corresponding to a first transmit power intensity, calculating a second impedance corresponding to a second transmit power intensity, and calculating a difference between the first impedance and the second impedance.

Here, the first transmit power intensity may be set such that a voltage applied to a load is maintained to be lower than or equal to a specific operating voltage, and the second transmit power intensity may be set such that the voltage applied to the load is maintained to be the specific operating voltage.

The first transmit power intensity and the second transmit power intensity may be set based on a class of the wireless power transmitter.

The first transmit power intensity and the second transmit power intensity may be set further based on a category of a wireless power receiver supportable according to the class of the wireless power transmitter.

The first transmit power intensity and the second transmit power intensity may be set based on a degree of change in intensity of a magnetic field corresponding to a power signal transmitted to sense the object in the charging area.

When the impedance change amount exceeds a predetermined reference value, it may be determined that the sensed object is the normal receiver.

When the impedance change amount is 0 or less than or equal to a predetermined reference value, it may be determined that the sensed object is not the normal receiver, wherein, when it is determined that the sensed object is not the normal receiver, it may be indicated that a foreign object (FO) has been sensed.

The sensing of the object in the charging area may include transmitting a periodic power signal for sensing the object, sensing change in the transmitted power signal, and sensing whether the object is placed in the charging area according to the sensed change in the power signal.

The periodic power signal may include at least one of a ping signal or a beacon signal.

In another embodiment, an apparatus for identifying a wireless power receiver may include a sensing unit configured to sense an object in a charging area, an impedance measurement unit configured to calculate an impedance change amount according to change in transmit power intensity when the object is sensed, and a receiver type determination unit configured to determined whether the sensed object is a normal receiver based on the impedance change amount and to identify, when it is determined that the object is the normal receiver, a type of he normal receiver based on the impedance change amount.

The impedance measurement unit may measure a first impedance corresponding to a first transmit power intensity and a second impedance corresponding to a second transmit power intensity, and determine a difference between the first impedance and the second impedance as the impedance change amount.

The first transmit power intensity and the second transmit power intensity may be set based on at least one of an operating voltage of the normal receiver, a class of the wireless power transmitter, a category of the wireless power receiver supportable according to the class of the wireless power transmitter, or a degree of change in intensity of a magnetic field corresponding to a periodic power signal for sensing the object in the charging area.

The receiver type determination unit may determine that the sensed object is the normal receiver when the impedance change amount exceeds a predetermined reference value, and may determine that the sensed object is a foreign object (FO) when the impedance change amount is less than or equal to the reference value or is 0.

The wireless power receiver identification apparatus may further include a power conversion unit configured to convert power into a predetermined intensity corresponding to the identified type.

The wireless power receiver identification apparatus may further include an output unit configured to display, when it is determined that the object is not the normal receiver, a predetermined notification message indicating that the FO has been sensed.

The apparatus may further include a receiver sensing signal generation unit configured to transmit a periodic power signal for sensing the object, wherein the sensing unit may sense whether the object is placed in the charging area based on change in intensity of a magnetic field corresponding to the transmitted periodic power signal.

The periodic power signal may include at least one of a ping signal or a beacon signal

When the communication connection with the object is not normally performed after the object is sensed, the impedance measurement unit may calculate an impedance change amount according to the change in the transmit power intensity.

In another embodiment, the wireless power transmitter may include a controller, a power converter configured to convert an intensity of power supplied from a power source into a DC power having a specific intensity according to a control signal of the controller, an amplifier configured to amplify the converted DC power, and a transmission unit configured to convert the amplified power into a power signal and wirelessly transmit the power signal, wherein the controller may determine whether an object sensed in the charging area is a normal receiver based on the impedance change amount according to change in the power intensity.

In another embodiment, an apparatus for identifying a wireless power receiver may include a sensing unit configured to sense an object in a charging area, an impedance measurement unit configured to calculate an impedance change amount according to change in transmit power intensity when the object is sensed, a controller configured to determine whether the object is a normal receiver based on the impedance change amount, and a transmitter configured to transmit a power signal to the normal receiver under control of the controller.

The impedance measurement unit may measure a first impedance corresponding to a first transmit power intensity and a second impedance corresponding to a second transmit power intensity, and determine a difference between the first impedance and the second impedance as the impedance change amount.

The controller may determine that the sensed object is the normal receiver when the impedance change amount exceeds a predetermined reference value, and may determine that the sensed object is a foreign object (FO) when the impedance change amount is less than or equal to the reference value or is 0.

The first transmit power intensity may be set such that a voltage applied to a load is maintained to be lower than or equal to a specific operating voltage, and the second transmit power intensity may be set such that the voltage applied to the load is maintained to be the specific operating voltage.

The first transmit power intensity and the second transmit power intensity may be set based on a class of the wireless power transmitter.

The first transmit power intensity and the second transmit power intensity may be set further based on a category of a wireless power receiver supportable according to the class of the wireless power transmitter.

The first transmit power intensity and the second transmit power intensity may be set based on a degree of change in intensity of a magnetic field corresponding to a power signal transmitted to sense the object in the charging area.

The apparatus may further include an output unit configured to display, when it is determined that the object is not the normal receiver, a predetermined notification message indicating that the FO has been sensed.

The apparatus may further include a receiver sensing signal generation unit configured to transmit a periodic power signal for sensing the object, wherein the sensing unit may sense whether the object is placed in the charging area based on change in intensity of a magnetic field corresponding to the transmitted periodic power signal.

The periodic power signal may include at least one of a ping signal or a beacon signal.

In another embodiment, a computer-readable recording medium having a program for executing any one of the methods for identifying a wireless power receiver recorded thereon may be provided.

The above-described aspects of the present disclosure are merely a part of preferred embodiments of the present disclosure. Those skilled in the art will derive and understand various embodiments reflecting the technical features of the present disclosure from the following detailed description of the present disclosure.

### Advantageous Effects

The method and apparatus according to the embodiments have the following effects.

Embodiments provide a method for identifying a wireless power receiver by a wireless power transmitter and an apparatus therefor.

Embodiments provide a wireless power receiver identification method and apparatus therefor that are capable of identifying a receiver capable of receiving wireless power even when communication is not possible.

Embodiments provide a wireless power reception apparatus identification method and apparatus therefor that are capable of not only identifying a normal receiver capable of receiving wireless power based on an impedance change pattern according to change in transmit power but also identifying the type and characteristics of the wireless power reception apparatus.

In addition, a device capable of receiving wireless power may be quickly identified before a communication connection is established.

It will be appreciated by those skilled in the art that that the effects that can be achieved through the embodiments of the present disclosure are not limited to those described above and other advantages of the present disclosure will be more clearly understood from the following detailed description.

### DESCRIPTION OF DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a system configuration diagram illustrating a wireless power transmission method using an electromagnetic resonance scheme according to an embodiment of the present disclosure;

FIG. 2 is a diagram illustrating a type and characteristics of a wireless power transmitter in an electromagnetic resonance scheme according to an embodiment of the present disclosure;

FIG. 3 is a diagram illustrating a type and characteristics of a wireless power receiver in an electromagnetic resonance scheme according to an embodiment of the present disclosure;

FIG. 4 shows equivalent circuit diagrams of a wireless power transmission system in an electromagnetic resonance scheme according to an embodiment of the present disclosure;

FIG. 5 is a state transition diagram illustrating a state transition procedure of a wireless power transmitter in an electromagnetic resonance scheme according to an embodiment of the present disclosure;

FIG. 6 is a state transition diagram illustrating a state transition procedure of a wireless power receiver in an electromagnetic resonance scheme according to an embodiment of the present disclosure;

FIG. 7 illustrates operation regions of a wireless power receiver according to VRECT in an electromagnetic resonance scheme according to an embodiment of the present disclosure;

FIG. 8 is a diagram illustrating a wireless charging system of an electromagnetic induction scheme according to an embodiment of the present disclosure;

FIG. 9 is a state transition diagram of a wireless power transmitter supporting an electromagnetic induction scheme according to an embodiment of the present disclosure;

FIG. 10 is an equivalent circuit diagram of a wireless power transmission system for explaining an impedance calculation method for a normal wireless power receiver according to an embodiment of the present disclosure;

FIG. 11 is an equivalent circuit diagram of a wireless power transmission system for explaining an impedance calculation method for an object which cannot be wirelessly charged, according to an embodiment of the present disclosure;

FIG. 12 shows a table for explaining change in impedance according to change in transmit power intensity according to an embodiment of the present disclosure.

FIG. 13 is an equivalent circuit diagram for explaining a method for measuring impedance by a wireless power transmitter according to an embodiment of the present disclosure;

FIG. 14 is a flowchart illustrating a method for identifying a wireless power receiver by a wireless power transmitter according to an embodiment of the present disclosure;

FIG. 15 illustrates the amount of change in impedance measured for each receiver according to an embodiment of the present disclosure;

FIG. 16 is a category mapping table according to an embodiment of the present disclosure;

FIG. 17 is a block diagram illustrating the structure of a wireless power transmitter according to an embodiment of the present disclosure;

FIG. 18 is a flowchart illustrating a method for identifying a wireless power receiver by a wireless power transmitter supporting an electromagnetic resonance scheme according to an embodiment of the present disclosure; and

FIG. 19 is a block diagram illustrating the structure of a wireless power transmitter according to another embodiment of the present disclosure.

### BEST MODE

A method for identifying a wireless power receiver by a wireless power transmitter according to a first embodiment of the present disclosure may include the steps of sensing an object in a charging area, calculating an amount of change in impedance according to change in transmit power intensity when the object is sensed, determining whether the object is a normal receiver based on the amount of change, and determining, when the object is the normal receiver as a result of the determination, a type of the normal receiver based on the amount of change in impedance.

### MODE FOR INVENTION

Hereinafter, an apparatus and various methods to which embodiments of the present disclosure are applied will be described in detail with reference to the drawings. As used herein, the suffixes “module” and “unit” are added or used interchangeably to facilitate preparation of this specification and are not intended to suggest distinct meanings or functions.

While all elements constituting embodiments of the present disclosure have been described as being connected into one body or operating in connection with each other, the disclosure is not limited to the described embodiments. That is, within the scope of the present disclosure, one or more of the elements may be selectively connected to operate. In addition, although all elements can be implemented as one independent hardware device, some or all of the elements may be selectively combined to implement a computer program having a program module for executing a part or all of the functions combined in one or more hardware devices. Code and code segments that constitute the computer program can be easily inferred by those skilled in the art. The computer program may be stored in a computer-readable storage medium, read and executed by a computer to implement an embodiment of the present disclosure. The storage medium of the computer program may include a magnetic recording medium, an optical recording medium, and a carrier wave medium.

In the description of the embodiments, it is to be understood that when an element is described as being “on” or “under” and “before” or “after” another element, it can be “directly” “on” or “under” and “before” or “after” another element or can be “indirectly” formed such that one or more other intervening elements are also present between the two elements.

The terms “include,” “comprise” and “have” should be understood as not precluding the possibility of existence or addition of one or more other components unless otherwise stated. All terms, including technical and scientific terms, have the same meaning as commonly understood by one of ordinary skill in the art to which this disclosure pertains, unless otherwise defined. Commonly used terms, such as those defined in typical dictionaries, should be interpreted as being consistent with the contextual meaning of the relevant art, and are not to be construed in an ideal or overly formal sense unless expressly defined to the contrary.

In describing the components of the present disclosure, terms such as first, second, A, B, (a), and (b) may be used. These terms are used only for the purpose of distinguishing one constituent from another, and the terms do not limit the nature, order or sequence of the components. When one component is said to be “connected,” “coupled” or “linked” to another, it should be understood that this means the one component may be directly connected or linked to another one or another component may be interposed between the components.

In the description of the embodiments, “wireless power transmitter,” “wireless power transmission device,” “transmission terminal,” “transmitter,” “transmission device,” “transmission side,” and the like will be interchangeably used to refer to a device for transmitting wireless power in a wireless power system, for simplicity.

In addition, “wireless power reception device,” “wireless power receiver,” “reception terminal,” “reception side,” “reception device,” “receiver,” and the like will be interchangeably used to refer to a device for receiving wireless power from a wireless power transmission device, for simplicity.

The wireless power transmitter according to the present disclosure may be configured as a pad type, a cradle type, an access point (AP) type, a small base station type, a stand type, a ceiling embedded type, a wall-mounted type, a vehicle embedded type, a vehicle resting type, or the like. One transmitter may transmit power to a plurality of wireless power reception devices at the same time.

To this end, the wireless power transmitter may provide at least one wireless power transmission scheme, including, for example, an electromagnetic induction scheme, an electromagnetic resonance scheme, and the like.

For example, for the wireless power transmission schemes, various wireless power transmission standards based on an electromagnetic induction scheme for charging using an electromagnetic induction principle in which a magnetic field is generated in a power transmission terminal coil and electricity is induced in a reception terminal coil by the influence of the magnetic field may be used. Here, the electromagnetic induction type wireless power transmission standards may include an electromagnetic induction type wireless charging technique defined in a Wireless Power Consortium (WPC) technique or a Power Matters Alliance (PMA) technique.

In another example, a wireless power transmission scheme may employ an electromagnetic resonance scheme in which a magnetic field generated by a transmission coil of a wireless power transmitter is tuned to a specific resonant frequency and power is transmitted to a wireless power receiver located at a short distance therefrom. For example, the electromagnetic resonance scheme may include a resonance type wireless charging technique defined in Alliance for Wireless Power (A4WP), which is a wireless charging technology standard organization.

In another example, a wireless power transmission scheme may employ an RF wireless power transmission scheme in which low power energy is transmitted to a wireless power receiver located at a remote location over an RF signal.

In another example of the present disclosure, the wireless power transmitter according to the present disclosure may be designed to support at least two wireless power transmission schemes among the electromagnetic induction scheme, the electromagnetic resonance scheme, and the RF wireless power transmission scheme.

In this case, the wireless power transmitter may determine not only a wireless power transmission scheme that the wireless power transmitter and the wireless power receiver are capable of supporting, but also a wireless power transmission scheme which may be adaptively used for the wireless power receiver based on the type, state, required power, etc. of the wireless power receiver.

A wireless power receiver according to an embodiment of the present disclosure may be provided with at least one wireless power transmission scheme, and may simultaneously receive wireless power from two or more wireless power transmitters. Here, the wireless power transmission scheme may include at least one of the electromagnetic induction scheme, the electromagnetic resonance scheme, and the RF wireless power transmission scheme.

The wireless power receiver according to the present disclosure may be embedded in small electronic devices such as a mobile phone, a smartphone, a laptop computer, a digital broadcast terminal, a PDA (Personal Digital Assistant), a PMP (Portable Multimedia Player), a navigation system, an MP3 player, an electric toothbrush, an electronic tag, a lighting device, a remote control, a fishing float, and the like. However, embodiments are not limited thereto, and the wireless power receiver may be applied to any devices which may be provided with the wireless power receiving means according to the present disclosure and be charged through a battery. A wireless power receiver according to another embodiment of the present disclosure may be mounted on a vehicle, an unmanned aerial vehicle, a drone, and the like.

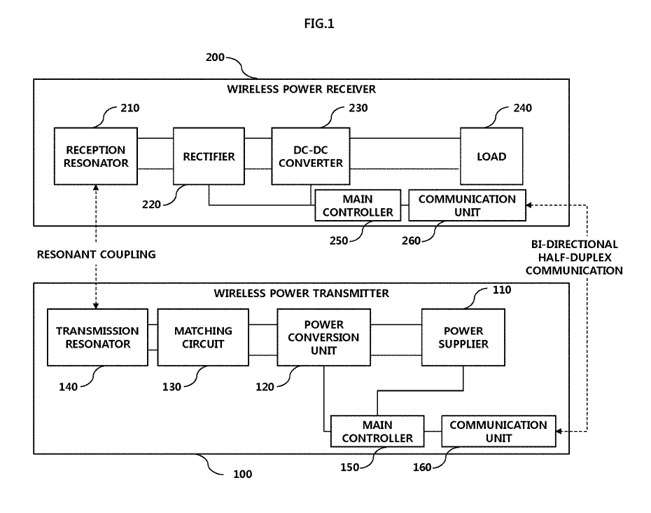

FIG. 1 is a system configuration diagram illustrating a wireless power transmission method using an electromagnetic resonance scheme according to an embodiment of the present disclosure.

Referring to FIG. 1, a wireless power transmission system may include a wireless power transmitter 100 and a wireless power receiver 200.

While FIG. 1 illustrates that the wireless power transmitter 100 transmits wireless power to one wireless power receiver 200, this is merely one embodiment, and the wireless power transmitter 100 according to another embodiment of the present disclosure may transmit wireless power to a plurality of wireless power receivers 200. It should be noted that the wireless power receiver 200 according to yet another embodiment may simultaneously receive wireless power from a plurality of wireless power transmitters 100.

The wireless power transmitter 100 may generate a magnetic field using a specific power transmission frequency (for example, a resonant frequency) to transmit power to the wireless power receiver 200.

The wireless power receiver 200 may receive power by tuning to the same frequency as the power transmission frequency used by the wireless power transmitter 100.

As an example, the frequency used for power transmission may be, but is not limited to, a 6.78 MHz band.

That is, the power transmitted by the wireless power transmitter 100 may be communicated to the wireless power receiver 200 that is in resonance with the wireless power transmitter 100.

The maximum number of wireless power receivers 200 capable of receiving power from one wireless power transmitter 100 may be determined based on the maximum transmit power level of the wireless power transmitter 100, the maximum power reception level of the wireless power receiver 200, and the physical structures of the wireless power transmitter 100 and the wireless power receiver 200.

The wireless power transmitter 100 and the wireless power receiver 200 can perform bidirectional communication in a frequency band different from the frequency band for wireless power transmission, i.e., the resonant frequency band. As an example, bidirectional communication may employ, without being limited to, a half-duplex Bluetooth low energy (BLE) communication protocol.

The wireless power transmitter 100 and the wireless power receiver 200 may exchange the characteristics and state information on each other including, for example, power negotiation information for power control via bidirectional communication.

As an example, the wireless power receiver 200 may transmit predetermined power reception state information for controlling the level of power received from the wireless power transmitter 100 to the wireless power transmitter 100 via bidirectional communication. The wireless power transmitter 100 may dynamically control the transmit power level based on the received power reception state information. Thereby, the wireless power transmitter 100 may not only optimize the power transmission efficiency, but also provide a function of preventing load breakage due to overvoltage, a function of preventing power from being wasted due to under-voltage, and the like.

The wireless power transmitter 100 may also perform functions such as authenticating and identifying the wireless power receiver 200 through bidirectional communication, identifying incompatible devices or non-rechargeable objects, identifying a valid load, and the like.

Hereinafter, a wireless power transmission process according to the resonance scheme will be described in more detail with reference to FIG. 1.

The wireless power transmitter 100 may include a power supplier 110, a power conversion unit 120, a matching circuit 130, a transmission resonator 140, a main controller 150, and a communication unit 160. The communication unit may include a data transmitter and a data receiver.

The power supplier 110 may supply a specific supply voltage to the power conversion unit 120 under control of the main controller 150. The supply voltage may be a DC voltage or an AC voltage.

The power conversion unit 120 may convert the voltage received from the power supplier 110 into a specific voltage under control of the main controller 150. To this end, the power conversion unit 120 may include at least one of a DC/DC converter, an AC/DC converter, and a power amplifier.

The matching circuit 130 is a circuit that matches impedances between the power conversion unit 120 and the transmission resonator 140 to maximize power transmission efficiency.

The transmission resonator 140 may wirelessly transmit power using a specific resonant frequency according to the voltage applied from the matching circuit 130.

The wireless power receiver 200 may include a reception resonator 210, a rectifier 220, a DC-DC converter 230, a load 240, a main controller 250 and a communication unit 260. The communication unit may include a data transmitter and a data receiver.

The reception resonator 210 may receive power transmitted by the transmission resonator 140 through the resonance effect.

The rectifier 220 may function to convert the AC voltage applied from the reception resonator 210 into a DC voltage.

The DC-DC converter 230 may convert the rectified DC voltage into a specific DC voltage required by the load 240.

The main controller 250 may control the operation of the rectifier 220 and the DC-DC converter 230 or may generate the characteristics and state information on the wireless power receiver 200 and control the communication unit 260 to transmit the characteristics and state information on the wireless power receiver 200 to the wireless power transmitter 100. For example, the main controller 250 may monitor the intensities of the output voltage and current from the rectifier 220 and the DC-DC converter 230 to control the operation of the rectifier 220 and the DC-DC converter 230.

The intensity information on the monitored output voltage and current may be transmitted to the wireless power transmitter 100 through the communication unit 260.

In addition, the main controller 250 may compare the rectified DC voltage with a predetermined reference voltage and determine whether the voltage is in an overvoltage state or an under-voltage state. When a system error state is sensed as a result of the determination, the controller 250 may transmit the sensed result to the wireless power transmitter 100 through the communication unit 260.

When the system error state is sensed, the main controller 250 may control the operation of the rectifier 220 and the DC-DC converter 230 or control the power applied to the load 240 using a predetermined overcurrent interruption circuit including a switch and/or a Zener diode, in order to prevent the load from being damaged.

In FIG. 1, the main controller 150 or 250 and the communication unit 160 or 260 of each of the transmitter and the receiver are shown as being configured as different modules, but this is merely one embodiment. It is to be noted that the main controller 150 or 250 and the communication unit 160 or 260 may be configured as a single module.

When an event such as addition of a new wireless power receiver to a, charging area during charging, disconnection of a wireless power receiver that is being charged, completion of charging of the wireless power receiver, or the like is sensed, the wireless power transmitter 100 according to an embodiment of the present disclosure may perform a power redistribution procedure for the remaining wireless power receivers to be charged. The result of power redistribution may be transmitted to the connected wireless power receiver(s) via out-of-band communication.

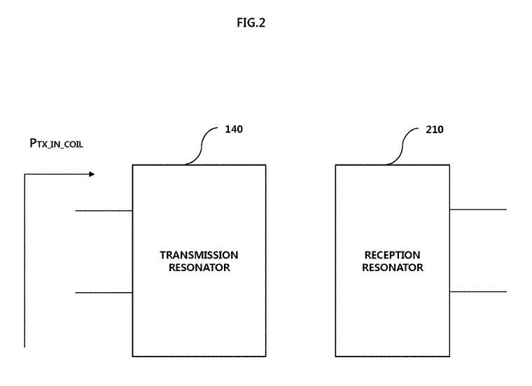

FIG. 2 is a diagram illustrating a type and characteristics of a wireless power transmitter in an electromagnetic resonance scheme according to an embodiment of the present disclosure.

Types and characteristics of the wireless power transmitter and the wireless power receiver according to the present disclosure may be classified into classes and categories.

The type and characteristics of the wireless power transmitter may be broadly identified by the following three parameters.

First, the wireless power transmitter may be identified by a class determined according to the intensity of the maximum power applied to the transmission resonator 140.

Here, the class of the wireless power transmitter may be determined by comparing the maximum value of the power P_{TX}_{_}_{IN}_{_}_{COIL} applied to the transmission resonator 140 with a predefined maximum input power for each class specified in a wireless power transmitter class table (hereinafter referred to as Table 1). Here, P_{TX}_{_}_{IN}_{_}_{COIL} may be an average real number value calculated by dividing the product of the voltage V(t) and the current I(t) applied to the transmission resonator 140 for a unit time by the unit time.

TABLE 1

| | | Minimum | |
|---|---|---|---|
| | | category | Maximum number |
| | Maximum input | support | of supportable |
| Class | power | requirements | devices |
| Class 1 | 2 W | 1 × Class 1 | 1 × Class 1 |
| Class 2 | 10 W | 1 × Class 3 | 2 × Class 2 |
| Class 3 | 16 W | 1 × Class 4 | 2 × Class 3 |
| Class 4 | 33 W | 1 × Class 5 | 3 × Class 3 |
| Class 5 | 50 W | 1 × Class 6 | 4 × Class 3 |
| Class 6 | 70 W | 1 × Class 6 | 5 × Class 3 |

The classes shown in Table 1 are merely an embodiment, and new classes may be added or existing classes may be deleted. It should also be noted that the maximum input power for each class, the minimum category support requirements, and the maximum number of supportable devices may vary depending on the use, shape, and implementation of the wireless power transmitter.

For example, referring to Table 1, when the maximum value of the power P_{TX}_{_}_{IN}_{_}_{COIL} applied to the transmission resonator 140 is greater than or equal to the value of P_{TX}_{_}_{IN}_{_}_{MAX} corresponding to Class 3 and less than the value of P_{TX}_{_}_{IN}_{_}_{MAX} corresponding to Class 4, the class of the wireless power transmitter may be determined as Class 3.

Second, the wireless power transmitter may be identified according to the minimum category support requirements corresponding to the identified class.

Here, the minimum category support requirement may be a supportable number of wireless power receivers corresponding to the highest level category of the wireless power receiver categories which may be supported by the wireless power transmitter of the corresponding class. That is, the minimum category support requirement may be the minimum number of maximum category devices which may be supported by the wireless power transmitter. In this case, the wireless power transmitter may support wireless power receivers of all categories lower than or equal to the maximum category according to the minimum category requirement.

However, if the wireless power transmitter is capable of supporting a wireless power receiver of a category higher than the category specified in the minimum category support requirement, the wireless power transmitter may not be restricted from supporting the wireless power receiver.

For example, referring to Table 1, a wireless power transmitter of Class 3 should support at least one wireless power receiver of Category 5. Of course, in this case, the wireless power transmitter may support a wireless power receiver 100 that falls into a category lower than the category level corresponding to the minimum category support requirement.

It should also be noted that the wireless power transmitter may support a wireless power receiver of a higher level category if it is determined that the category whose level is higher than the category corresponding to the minimum category support requirement can be supported.

Third, the wireless power transmitter may be identified by the maximum number of supportable devices corresponding to the identified class. Here, the maximum number of supportable devices may be identified by the maximum number of supportable wireless power receivers corresponding to the lowest level category among the categories which are supportable in the class—hereinafter, simply referred to as the maximum number of supportable devices.

For example, referring to Table 1, the wireless power transmitter of Class 3 should support up to two wireless power receivers corresponding to Category 3 which is the lowest level category.

However, when the wireless power transmitter is capable of supporting more than the maximum number of devices corresponding to its own class, it is not restricted from supporting more than the maximum number of devices.

The wireless power transmitter according to the present disclosure must perform wireless power transmission within the available power for up to at least the number defined in Table 1 if there is no particular reason not to allow the power transmission request from the wireless power receivers.

In one example, if there is not enough available power to accept the power transmission request the wireless power transmitter may not accept a power transmission request from the wireless power receiver. Alternatively, it may control power adjustment of the wireless power receiver.

In another example, when the wireless power transmitter accepts a power transmission request, it may not accept a power transmission request from a corresponding wireless power receiver if the number of acceptable wireless power receivers is exceeded.

In another example, the wireless power transmitter may not accept a power transmission request from a wireless power receiver if the category of the wireless power receiver requesting power transmission exceeds a category level that is supportable in the class of the wireless power transmitter.

In another example, the wireless power transmitter may not accept a power transmission request of the wireless power receiver if the internal temperature thereof exceeds a reference value.

In particular, the wireless power transmitter according to the present disclosure may perform the power redistribution procedure based on the currently available power. The power redistribution procedure may be performed further considering at least one of a category, a wireless power reception state, a required power, a priority, and a consumed power of a wireless power receiver for power transmission, which will be described later.

Information on the at least one of the category, wireless power reception state, required power, priority, and consumed power of the wireless power receiver may be transmitted from the wireless power receiver to the wireless power transmitter through at least one control signal over an out-of-band communication channel.

Once the power redistribution procedure is completed, the wireless power transmitter may transmit the power redistribution result to the corresponding wireless power receiver via out-of-band communication.

The wireless power receiver may recalculate the estimated time required to complete charging based on the received power redistribution result and transmit the re-calculation result to the microprocessor of a connected electronic device. Subsequently, the microprocessor may control the display provided to the electronic device to display the recalculated estimated charging completion time. At this time, the displayed estimated charging completion time may be controlled so as to disappear after being displayed for a predetermined time.

According to another embodiment of the present disclosure, when the estimated time required to complete charging is recalculated, the microprocessor may control the recalculated estimated charging completion to be displayed together with information on the reason for re-calculation. To this end, the wireless power transmitter may also transmit the information on the reason for occurrence of power redistribution to the wireless power receiver when transmitting the power redistribution result.

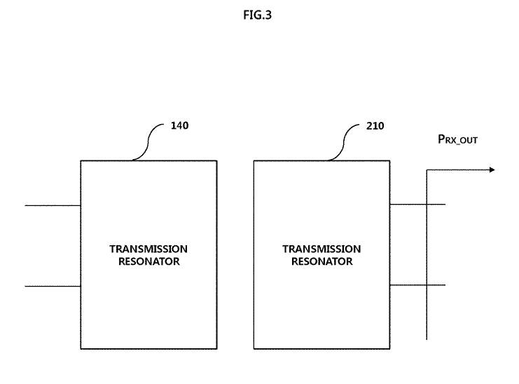

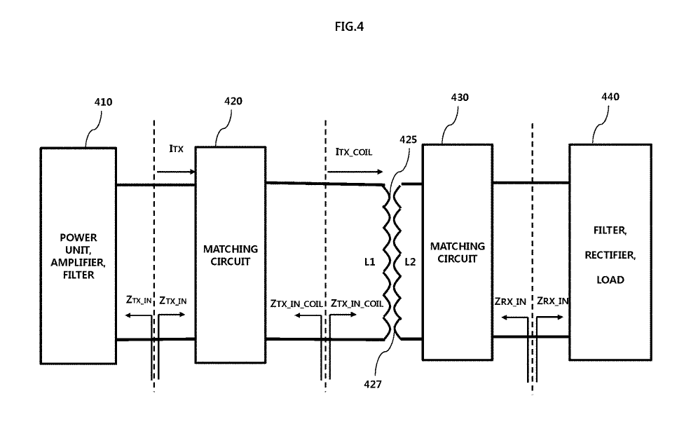

FIG. 3 is a diagram illustrating a type and characteristics of a wireless power receiver in an electromagnetic resonance scheme according to an embodiment of the present disclosure.

As shown in FIG. 3, the average output power P_{RX}_{_}_{OUT} of the reception resonator 210 is a real number value calculated by dividing the product of the voltage V(t) and the current I(t) output by the reception resonator 210 for a unit time by the unit time.

The category of the wireless power receiver may be defined based on the maximum output power P_{RX}_{_}_{OUT}_{_}_{MAX} of the reception resonator 210, as shown in Table 2 below.

TABLE 2

| | Maximum input | Application |
|---|---|---|
| Category | power | example |
| Category 1 | TBD | Bluetooth |
| | | handset |
| Category 2 | 3.5 W | Feature phone |
| Category 3 | 6.5 W | Smartphone |
| Category 4 | 13 W | Tablet |
| Category 5 | 25 W | Small laptop |
| Category 6 | 37.5 W | Laptop |
| Category 6 | 50 W | TBD |

For example, if the charging efficiency at the load stage is 80% or more, the wireless power receiver of Category 3 may supply power of 5 W to the charging port of the load.

The categories disclosed in Table 2 are merely an embodiment, and new categories may be added, or existing categories may be deleted. It should also be noted that the maximum output power for each category and application examples shown in Table 2 may vary depending on the use, shape and implementation of the wireless power receiver.

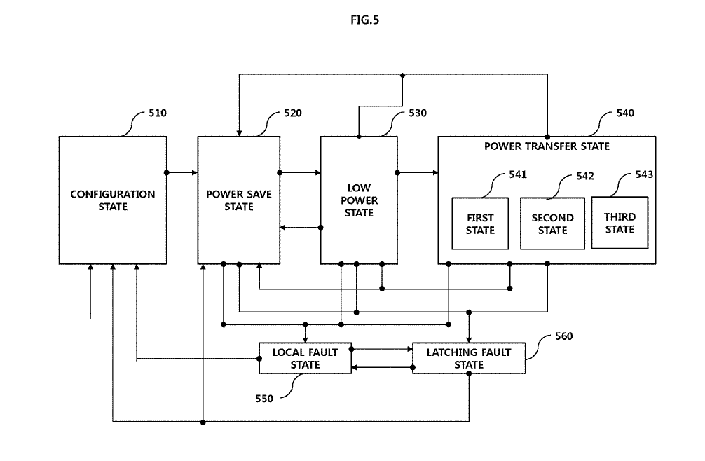

FIG. 4 shows equivalent circuit diagrams of a wireless power transmission system in an electromagnetic resonance scheme according to an embodiment of the present disclosure.

Specifically, FIG. 4 shows interface points on the equivalent circuit at which reference parameters, which will be described later, are measured.

Hereinafter, meanings of the reference parameters shown in FIG. 4 will be briefly described.

I_{TX} and I_{TX}_{_}_{COIL} denote the RMS (Root Mean Square) current applied to the matching circuit (or matching network) 420 of the wireless power transmitter and the RMS current applied to the transmission resonator coil 425 of the wireless power transmitter.

Z_{TX}_{_}_{IN} denotes the input impedance at the rear end of the power unit/amplifier/filter 410 of the wireless power transmitter and the input impedance at the front end of the matching circuit 420.

Z_{TX}_{_}_{IN}_{_}_{COIL} denotes the input impedance at the rear end of the matching circuit 420 and the front end of the transmission resonator coil 425.

L1 and L2 denote the inductance value of the transmission resonator coil 425 and the inductance value of the reception resonator coil 427, respectively.

Z_{RX}_{_}_{IN} denotes the input impedance at the rear end of the matching circuit 430 of the wireless power receiver and the front end of the filter/rectifier/load 440 of the wireless power receiver.

The resonant frequency used in the operation of the wireless power transmission system according to an embodiment of the present disclosure may be 6.78 MHz±15 kHz.

In addition, the wireless power transmission system according to an embodiment may provide simultaneous charging (i.e., multi-charging) for a plurality of wireless power receivers. In this case, even if a wireless power receiver is newly added or removed, the received power variation of the remaining wireless power receivers may be controlled so as not to exceed a predetermined reference value. For example, the received power variation may be ±10%, but embodiments are not limited thereto. If it is not possible to control the received power variation not to exceed the reference value, the wireless power transmitter may not accept the power transmission request from the newly added wireless power receiver.

The condition for maintaining the received power variation is that the existing wireless power receivers should not overlap a wireless power receiver that is added to or removed from the charging area.

When the matching circuit 430 of the wireless power receiver is connected to the rectifier, the real part of Z_{TX}_{_}_{IN} may be inversely proportional to the load resistance of the rectifier (hereinafter, referred to as R_{RECT}). That is, an increase in R_{RECT} may decrease Z_{TX}_{_}_{IN}, and a decrease in R_{RECT} may increase Z_{TX}_{_}_{IN}.

The resonator coupling efficiency according to the present disclosure may be a maximum power reception ratio calculated by dividing the power transmitted from the reception resonator coil to the load 440 by the power carried in the resonant frequency band in the transmission resonator coil 425. The resonator coupling efficiency between the wireless power transmitter and the wireless power receiver may be calculated when the reference port impedance Z_{TX}_{_}_{IN} of the transmission resonator and the reference port impedance Z_{RX}_{_}_{IN} of the reception resonator are perfectly matched.

Table 3 below is an example of the minimum resonator coupling efficiencies according to the classes of the wireless power transmitter and the classes of the wireless power receiver according to an embodiment of the present disclosure.

TABLE 3

| | Category 1 | Category 2 | Category 3 | Category 4 | Category 5 | Category 6 | Category 7 |
|---|---|---|---|---|---|---|---|
| Class 1 | N/A | N/A | N/A | N/A | N/A | N/A | N/A |
| Class 2 | N/A | 74% (−1.3) | 74% (−1.3) | N/A | N/A | N/A | N/A |
| Class 3 | N/A | 74% (−1.3) | 74% (−1.3) | 76% (−1.2) | N/A | N/A | N/A |
| Class 4 | N/A | 50% (−3) | 65% (−1.9) | 73% (−1.4) | 76% (−1.2) | N/A | N/A |
| Class 5 | N/A | 40% (−4) | 60% (−2.2) | 63% (−2) | 73% (−1.4) | 76% (−1.2) | N/A |
| Class 5 | N/A | 30% (−5.2) | 50% (−3) | 54% (−2.7) | 63% (−2) | 73% (−1.4) | 76% (−1.2) |

When a plurality of wireless power receivers is used, the minimum resonator coupling efficiencies corresponding to the classes and categories shown in Table 3 may increase.

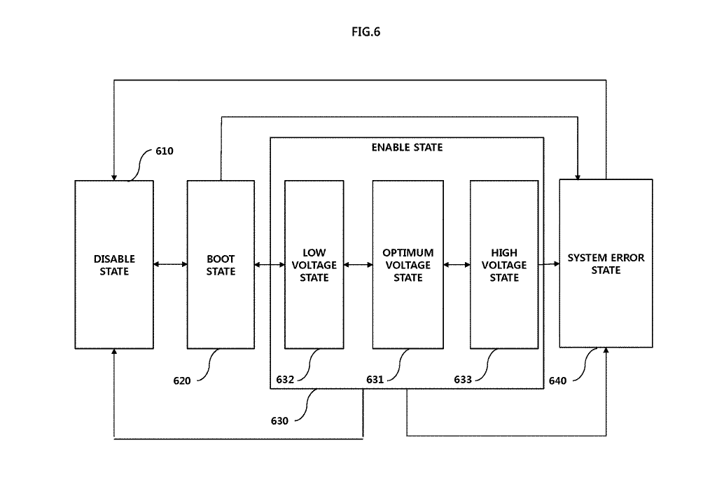

FIG. 5 is a state transition diagram illustrating a state transition procedure of a wireless power transmitter that supports the electromagnetic resonance scheme according to an embodiment of the present disclosure.

Referring to FIG. 5, the states of the wireless power transmitter may include a configuration state 510, a power save state 520, a low power state 530, a power transfer state 540, a local fault state 550, and a latching fault state 560.

When power is applied to the wireless power transmitter, the wireless power transmitter may transition to the configuration state 510. The wireless power transmitter may transition to a power save state 520 when a predetermined reset timer expires in the configuration state 510 or the initialization procedure is completed.

In the power save state 520, the wireless power transmitter may generate a beacon sequence and transmit the same through a resonant frequency band.

Here, the wireless power transmitter may control the beacon sequence to be initiated within a predetermined time after entering the power save state 520. For example, the wireless power transmitter may control the beacon sequence to be initiated within 50 ms after transition to the power save state 520. However, embodiments are not limited thereto.

In the power save state 520, the wireless power transmitter may periodically generate and transmit a first beacon sequence for sensing a wireless power receiver, and sense change in impedance of the reception resonator, that is, load variation. Hereinafter, for simplicity, the first beacon and the first beacon sequence will be referred to as a short beacon and a short beacon sequence, respectively.

In particular, the short beacon sequence may be repeatedly generated and transmitted at a constant time interval t_{CYCLE} during a short period t_{SHORT}_{_}_{BEACON} such that the standby power of the wireless power transmitter may be saved until a wireless power receiver is sensed. For example, t_{SHORT}_{_}_{BEACON} may be set to 30 ms or less, and t_{CYCLE} may be set to 250 ms±5 ms. In addition, the current intensity of the short beacon may be greater than a predetermined reference value, and may be gradually increased during a predetermined time period. For example, the minimum current intensity of the short beacon may be set to be sufficiently large such that a wireless power receiver of Category 2 or a higher category in Table 2 above may be sensed.

The wireless power transmitter according to the present disclosure may be provided with a predetermined sensing means for sensing change in reactance and resistance of the reception resonator according to the short beacon.

In addition, in the power save state 520, the wireless power transmitter may periodically generate and transmit a second beacon sequence for providing sufficient power necessary for booting and response of the wireless power receiver. Hereinafter, for simplicity, the second beacon and the second beacon sequence will be referred to as a long beacon and a long beacon sequence, respectively.

That is, the wireless power receiver may broadcast a predetermined response signal over an out-of-band communication channel when booting is completed through the second beacon sequence.

In particular, the long beacon sequence may be generated and transmitted at a constant time interval t_{LONG}_{_}_{BEACON}_{_}_{PERIOD} during a relatively long period t_{LONG}_{_}_{BEACON} compared to the short beacon to supply sufficient power necessary for booting the wireless power receiver. For example, t_{LONG}_{_}_{BEACON} may be set to 105 ms+5 ms, and t_{LONG}_{_}_{BEACON}_{_}_{PERIOD} may be set to 850 ms. The current intensity of the long beacon may be stronger than the current intensity of the short beacon. In addition, the long beacon may maintain the power of a certain intensity during the transmission period.

Thereafter, the wireless power transmitter may wait to receive a predetermined response signal during the long beacon transmission period after change in impedance of the reception resonator is sensed. Hereinafter, for simplicity, the response signal will be referred to as an advertisement signal. Here, the wireless power receiver may broadcast the advertisement signal in an out-of-band communication frequency band that is different from the resonant frequency band.

In one example, the advertisement signal may include at least one or any one of message identification information for identifying a message defined in the out-of-band communication standard, a unique service or wireless power receiver identification information for identifying whether the wireless power receiver is legitimate or compatible with the wireless power transmitter, information about the output power of the wireless power receiver, information about the rated voltage/current applied to the load, antenna gain information about the wireless power receiver, information for identifying the category of the wireless power receiver, wireless power receiver authentication information, information about whether or not the overvoltage protection function is provided, and version information about the software installed on the wireless power receiver.

Upon receiving the advertisement signal, the wireless power transmitter may establish an out-of-band communication link with the wireless power receiver after transitioning from the power save state 520 to the low power state 530. Subsequently, the wireless power transmitter may perform the registration procedure for the wireless power receiver over the established out-of-band communication link. For example, if the out-of-band communication is Bluetooth low-power communication, the wireless power transmitter may perform Bluetooth pairing with the wireless power receiver and exchange at least one of the state information, characteristic information, and control information about each other via the paired Bluetooth link.

If the wireless power transmitter transmits a predetermined control signal for initiating charging via out-of-band communication, i.e., a predetermined control signal for requesting that the wireless power receiver transmit power to the load, to the wireless power receiver in the low power state 530, the state of the wireless power transmitter may transition from the low power state 530 to the power transfer state 540.

If the out-of-band communication link establishment procedure or registration procedure is not normally completed in the low power state 530, the wireless power transmitter may transition from the low power state 530 to the power save state 520.

A separate independent link expiration timer by which the wireless power transmitter may connect to each wireless power receiver may be driven, and the wireless power receiver may transmit a predetermined message for announcing its presence to the wireless power transmitter in a predetermined time cycle before the link expiration timer expires. The link expiration timer is reset each time the message is received. If the link expiration timer does not expire, the out-of-band communication link established between the wireless power receiver and the wireless power receiver may be maintained.

If all of the link expiration timers corresponding to the out-of-band communication link established between the wireless power transmitter and the at least one wireless power receiver have expired in the low power state 530 or the power transfer state 540, the wireless power transmitter may transition to the power save state 520.

In addition, the wireless power transmitter in the low power state 530 may drive a predetermined registration timer when a valid advertisement signal is received from the wireless power receiver. When the registration timer expires, the wireless power transmitter in the low power state 530 may transition to the power save state 520. At this time, the wireless power transmitter may output a predetermined notification signal notifying that registration has failed through a notification display means (including, for example, an LED lamp, a display screen, and a beeper) provided in the wireless power transmitter.

Further, in the power transfer state 540, when charging of all connected wireless power receivers is completed, the wireless power transmitter may transition to the low power state 530.

In particular, the wireless power receiver may allow registration of a new wireless power receiver in states other than the configuration state 510, the local fault state 550, and the latching fault state 560.

In addition, the wireless power transmitter may dynamically control the transmit power based on the state information received from the wireless power receiver in the power transfer state 540.

Here, the receiver state information transmitted from the wireless power receiver to the wireless power transmitter may include at least one of required power information, information on the voltage and/or current measured at the rear end of the rectifier, charge state information, information indicating the overcurrent, overvoltage and/or overheated state, and information indicating whether or not a means for cutting off or reducing power transferred to the load according to the overcurrent or the overvoltage is activated. The receiver state information may be transmitted with a predetermined periodicity or transmitted every time a specific event is generated. In addition, the means for cutting off or reducing the power transferred to the load according to the overcurrent or overvoltage may be provided using at least one of an ON/OFF switch and a Zener diode.

According to another embodiment, the receiver state information transmitted from the wireless power receiver to the wireless power transmitter may further include at least one of information indicating that an external power source is connected to the wireless power receiver by wire and information indicating that the out-of-band communication scheme has changed (e.g., the communication scheme may change from NFC (Near Field Communication) to BLE (Bluetooth Low Energy) communication).

According to another embodiment of the present disclosure, a wireless power transmitter may adaptively determine the intensity of power to be received by each wireless power receiver based on at least one of the currently available power of the power transmitter, the priority of each wireless power receiver, and the number of connected wireless power receivers. Here, the power intensity of each wireless power receiver may be determined as a proportion of power to be received with respect to the maximum power that may be processed by the rectifier of the corresponding wireless power receiver.

Here, the priorities of the wireless power receivers may be determined according to the intensity of power required by the receiver, the type of the receiver, current use of the receiver, the current charge amount, the current consumed power, and the like, but embodiments are not limited thereto. For example, the priority of each type of receiver may be determined in order of cellular phone, tablet, Bluetooth headset, and electric toothbrush, but embodiments are not limited thereto. In another example, when a receiver is currently in use, it may be assigned a higher priority than receivers which are not in use. As another example, the higher the power required by the receiver, the higher the assigned priority may be. In another example, the priority may be determined based on the current charge amount of the load mounted on the receiver, that is, the remaining charge amount. In another example, the priorities may be determined based on the power currently being consumed. It should also be noted that priorities may be determined by a combination of at least one of the above-described prioritization factors.

Thereafter, the wireless power transmitter may transmit, to the wireless power receiver, a predetermined power control command including information about the determined power intensity. Then, the wireless power receiver may determine whether power control can be performed based on the power intensity determined by the wireless power transmitter, and transmit the determination result to the wireless power transmitter through a predetermined power control response message.

According to another embodiment of the present disclosure, a wireless power receiver may transmit predetermined receiver state information indicating whether wireless power control can be performed according to a power control command of a wireless power transmitter before receiving the power control command.

The power transfer state 540 may be any one of a first state 541, a second state 542 and a third state 543 depending on the power reception state of the connected wireless power receiver.

In one example, the first state 541 may indicate that the power reception state of all wireless power receivers connected to the wireless power transmitter is a normal voltage state.

The second state 542 may indicate that the power reception state of at least one wireless power receiver connected to the wireless power transmitter is a low voltage state and there is no wireless power receiver which is in a high voltage state.

The third state 543 may indicate that the power reception state of at least one wireless power receiver connected to the wireless power transmitter is a high voltage state.

When a system error is sensed in the power save state 520, the low power state 530, or the power transfer state 540, the wireless power transmitter may transition to the latching fault state 560.

The wireless power transmitter in the latching fault state 560 may transition to either the configuration state 510 or the power save state 520 when it is determined that all connected wireless power receivers have been removed from the charging area.

In addition, when a local fault is sensed in the latching fault state 560, the wireless power transmitter may transition to the local fault state 550. Here, the wireless power transmitter in the local fault state 550 may transition back to the latching fault state 560 when the local fault is released.

On the other hand, in the case where the wireless power transmitter transitions from any one state among the configuration state 510, the power save state 520, the low power state 530, and the power transfer state 540 to the local fault state 550, the wireless power transmitter may transition to the configuration state 510 once the local fault is released.

The wireless power transmitter may interrupt the power supplied to the wireless power transmitter once it transitions to the local fault state 550. For example, the wireless power transmitter may transition to the local fault state 550 when a fault such as overvoltage, overcurrent, or overheating is sensed. However, embodiments are not limited thereto.

In one example, the wireless power transmitter may transmit, to at least one connected wireless power receiver, a predetermined power control command for reducing the intensity of power received by the wireless power receiver when overcurrent, overvoltage, or overheating is sensed.

In another example, the wireless power transmitter may transmit, to at least one connected wireless power receiver, a predetermined control command for stopping charging of the wireless power receiver when overcurrent, overvoltage, or overheating is sensed.

Through the above-described power control procedure, the wireless power transmitter may prevent damage to the device due to overvoltage, overcurrent, overheating, or the like.

If the intensity of the output current of the transmission resonator is greater than or equal to a reference value, the wireless power transmitter may transition to the latching fault state 560. The wireless power transmitter that has transitioned to the latching fault state 560 may attempt to make the intensity of the output current of the transmission resonator less than or equal to a reference value for a predetermined time. Here, the attempt may be repeated a predetermined number of times. If the latching fault state 560 is not released despite repeated execution, the wireless power transmitter may send, to the user, a predetermined notification signal indicating that the latching fault state 560 is not released, using a predetermined notification means. In this case, when all of the wireless power receivers positioned in the charging area of the wireless power transmitter are removed from the charging area by the user, the latching fault state 560 may be released.

On the other hand, if the intensity of the output current of the transmission resonator falls below the reference value within a predetermined time, or if the intensity of the output current of the transmission resonator falls below the reference value during the predetermined repetition, the latching fault state 560 may be automatically released. In this case, the wireless power transmitter may automatically transition from the latching fault state 560 to the power save state 520 to perform the sensing and identification procedure for a wireless power receiver again.

The wireless power transmitter in the power transfer state 540 may transmit continuous power and adaptively control the transmit power based on the state information on the wireless power receiver and predefined optimal voltage region setting parameters.

For example, the predefined optimal voltage region setting parameters may include at least one of a parameter for identifying a low voltage region, a parameter for identifying an optimum voltage region, a parameter for identifying a high voltage region, and a parameter for identifying an overvoltage region.

The wireless power transmitter may increase the transmit power if the power reception state of the wireless power receiver is in the low voltage region, and reduce the transmit power if the power reception state is in the high voltage region.

The wireless power transmitter may also control the transmit power to maximize power transmission efficiency.

The wireless power transmitter may also control the transmit power such that the deviation of the power required by the wireless power receiver is less than or equal to a reference value.

In addition, the wireless power transmitter may stop transmitting power when the output voltage of the rectifier of the wireless power receiver reaches a predetermined overvoltage region, namely, when overvoltage is sensed.

FIG. 6 is a state transition diagram illustrating a state transition procedure of a wireless power receiver in an electromagnetic resonance scheme according to an embodiment of the present disclosure.

Referring to FIG. 6, the states of the wireless power receiver may include a disable state 610, a boot state 620, an enable state (or on state) 630 and a system error state 640.

The state of the wireless power receiver may be determined based on the intensity of the output voltage at the rectifier end of the wireless power receiver (hereinafter referred to as V_{RECT} for simplicity).

The enable state 630 may be divided into an optimum voltage 631, a low voltage state 632 and a high voltage state 633 according to the value of V_{RECT}.

The wireless power receiver in the disable state 610 may transition to the boot state 620 if the measured value of V_{RECT} is greater than or equal to the predefined value of V_{RECT}_{_}_{BOOT}.

In the boot state 620, the wireless power receiver may establish an out-of-band communication link with a wireless power transmitter and wait until the value of V_{RECT} reaches the power required at the load stage.

When it is sensed that the value of V_{RECT} has reached the power required at the load stage, the wireless power receiver in the boot state 620 may transition to the enable state 630 and begin charging.

The wireless power receiver in the enable state 630 may transition to the boot state 620 when it is sensed that charging is completed or interrupted.

In addition, the wireless power receiver in the enable state 630 may transition to the system error state 640 when a predetermined system error is sensed. Here, the system error may include overvoltage, overcurrent, and overheating, as well as other predefined system error conditions.

In addition, the wireless power receiver in the enable state 630 may transition to the disable state 610 if the value of V_{RECT} falls below the value of V_{RECT}_{_}_{BOOT}.

In addition, the wireless power receiver in the boot state 620 or the system error state 640 may transition to the disable state 610 if the value of V_{RECT} falls below the value of V_{RECT}_{_}_{BOOT}.

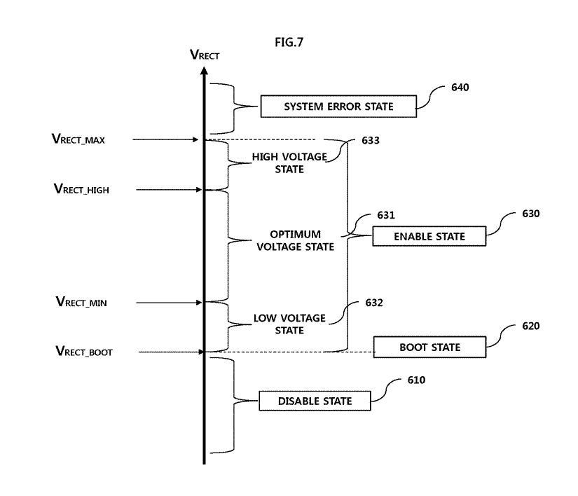

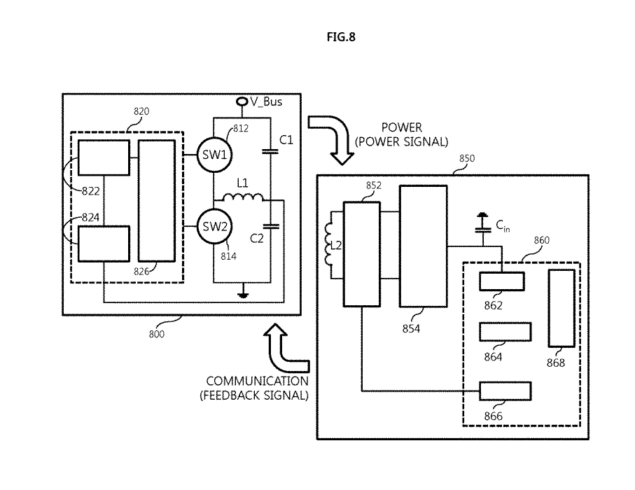

Hereinafter, state transition of the wireless power receiver in the enable state 630 will be described in detail with reference to FIG. 7.

FIG. 7 illustrates operation regions of a wireless power receiver according to V_{RECT} in an electromagnetic resonance scheme according to an embodiment of the present disclosure.

Referring to FIG. 7, if the value of V_{RECT} is less than a predetermined value of V_{RECT}_{_}_{BOOT}, the wireless power receiver is maintained in the disable state 610.

Thereafter, when the value of V_{RECT} is increased beyond V_{RECT}_{_}_{BOOT}, the wireless power receiver may transition to the boot state 620 and broadcast an advertisement signal within a predetermined time. Thereafter, when the advertisement signal is sensed by the wireless power transmitter, the wireless power transmitter may transmit a predetermined connection request signal for establishing an out-of-band communication link to the wireless power receiver.

Once the out-of-band communication link is normally established and successfully registered, the wireless power receiver may wait until the value of V_{RECT} reaches the minimum output voltage of the rectifier for normal charging (hereinafter referred to as V_{RECT}_{_}_{MIN} for simplicity).

If the value of V_{RECT} exceeds V_{RECT}_{_}_{MIN}, the wireless power receiver may transition from the boot state 620 to the enable state 630 and may begin charging the load.

If the value of V_{RECT} in the enable state 630 exceeds a predetermined reference value V_{RECT-MAX} for determining overvoltage, the wireless power receiver may transition from the enable state 630 to the system error state 640.

Referring to FIG. 7, the enable state 630 may be divided into the low voltage state 632, the optimum voltage 631 and the high voltage state 633 according to the value of V_{RECT}.

The low voltage state 632 may refer to a state in which V_{RECT}_{_}_{BOOT}≤V_{RECT}≤V_{RECT}_{_}_{MIN}, the optimum voltage state 631 may refer to a state in which V_{RECT}_{_}_{MIN}<V_{RECT}≤V_{RECT}_{_}_{HIGH} and the high voltage state 633 may refer to a state in which V_{RECT}_{_}_{HIGH}<V_{RECT}≤V_{RECT}_{_}_{MAX}.

In particular, the wireless power receiver having transitioned to the high voltage state 633 may suspend the operation of cutting off the power supplied to the load for a predetermined time (hereinafter referred to as a high voltage state maintenance time for simplicity). The high voltage state maintenance time may be predetermined so as not to cause damage to the wireless power receiver and the load in the high voltage state 633.

When the wireless power receiver transitions to the system error state 640, it may transmit a predetermined message indicating occurrence of overvoltage to the wireless power transmitter through the out-of-band communication link within a predetermined time.

The wireless power receiver may also control the voltage applied to the load using an overvoltage interruption means provided to prevent damage to the load due to the overvoltage in the system fault state 630. Here, an ON/OFF switch and/or a Zener diode may be used as the overvoltage interruption means.

Although a method and means for coping with a system error in a wireless power receiver when overvoltage is generated and the wireless power receiver transitions to the system error state 640 have been described in the above embodiment, this is merely an embodiment. In other embodiments, the wireless power receiver may transition to the system error state due to overheating, overcurrent, and the like.

As an example, in the case where the wireless power receiver transitions to the system error state due to overheating, the wireless power receiver may transmit a predetermined message indicating the occurrence of overheating to the wireless power transmitter. In this case, the wireless power receiver may drive a cooling fan or the like to reduce the internally generated heat.

According to another embodiment of the present disclosure, a wireless power receiver may receive wireless power in conjunction with a plurality of wireless power transmitters. In this case, the wireless power receiver may transition to the system error state 640 if it is determined that the wireless power transmitter from which the wireless power receiver is determined to actually receive wireless power is different from the wireless power transmitter with which the out-of-band communication link is actually established.

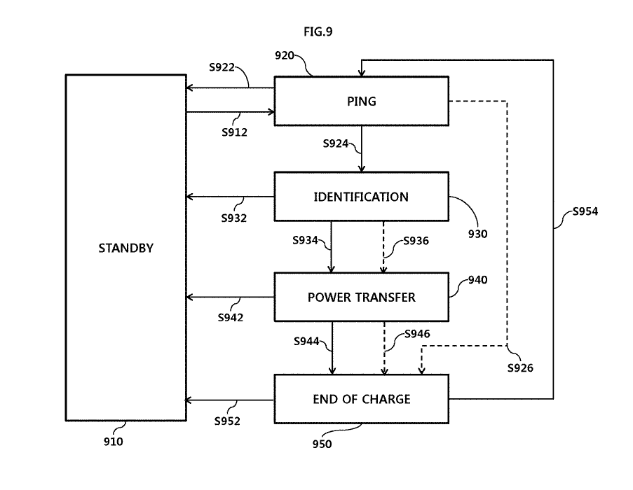

FIG. 8 is a diagram illustrating a wireless charging system of an electromagnetic induction scheme according to an embodiment of the present disclosure.

Referring to FIG. 8, a wireless charging system according to the electromagnetic induction scheme includes a wireless power transmitter 800 and a wireless power receiver 850. By placing an electronic device including the wireless power receiver 850 on the wireless power transmitter 800, the coils of the wireless power transmitter 800 and the wireless power receiver 850 may be coupled by an electromagnetic field.

The wireless power transmitter 800 may modulate a power signal and change the frequency to create an electromagnetic field for power transmission. The wireless power receiver 850 may receive power by demodulating the electromagnetic signal according to the protocol set to be suitable for the wireless communication environment and transmit a predetermined feedback signal to the wireless power transmitter 100 via in-band communication based on the intensity of the received power to control the intensity of the transmit power of the wireless power transmitter 800. For example, the wireless power transmitter 800 may control the operating frequency according to a control signal for power control to increase or decrease the transmit power.

The increase/decrease of power transmitted may be controlled using a feedback signal transmitted from the wireless power receiver 850 to the wireless power transmitter 800. Communication between the wireless power receiver 850 and the wireless power transmitter 800 is not limited to in-band communication using the feedback signal described above, but may also be performed using out-of-band communication provided with a separate communication module. For example, short-range wireless communication modules such as a Bluetooth module, a Bluetooth Low Energy (BLE) module, an NFC module, and a ZigBee module may be used.

In the electromagnetic induction scheme, a frequency modulation scheme may be used as a protocol for exchanging state information and control signals between the wireless power transmitter 800 and the wireless power receiver 850. The device identification information, the charging state information, the power control signal, and the like may be exchanged through the protocol.

As shown in FIG. 8, the wireless power transmitter 800 according to an embodiment of the present disclosure includes a signal generator 820 for generating a power signal, a coil L1 and capacitors C1 and C2 positioned between the power supply terminals V_Bus and GND capable of sensing a feedback signal transmitted from the wireless power receiver 850, and switches SW1 and SW2 whose operation is controlled by the signal generator 820.

The signal generator 820 may include a demodulator 824 for demodulating a feedback signal transmitted through the coil L1, a frequency driver 826 for changing the frequency, and a transmission controller 822 for controlling the modulator 824 and the frequency driver 826. The feedback signal transmitted through the coil L1 may be demodulated by the demodulation unit 824 and then input to the transmission controller 822. The transmission controller 822 may control the frequency driver 826 based on the demodulated signal to change the frequency of the power signal transmitted through the coil L1.

The wireless power receiver 850 may include a modulator 852 for transmitting a feedback signal through a coil L2, a rectifier 854 for converting an AC signal received through the coil L2 into a DC signal, and a reception controller 860 for controlling the modulator 852 and the rectifier 854. The reception controller 860 may include a power supplier 862 for supplying power necessary for operation of the rectifier 854 and the wireless power receiver 850, and a DC-DC converter 864 for changing the DC output voltage of the rectifier 854 to a DC voltage satisfying the charging requirements of a charging target (a load 868), a load 868 for outputting the converted power, and a feedback communication unit 866 for generating a feedback signal for providing a receive power state and a charging target state to the wireless power transmitter 800.

The operation state of the wireless charging system supporting the electromagnetic induction scheme may be broadly classified into a standby state, a signal detection state, an identification confirmation state, a power transfer state, and an end-of-charge state. Transition to a different operation state may be performed according to a result of feedback communication between the wireless power receiver 850 and the wireless power transmitter 800. Transition between the standby state and the signal detection state may be performed using a predetermined receiver detection method for detecting presence of the wireless power receiver 800.

FIG. 9 is a state transition diagram of a wireless power transmitter supporting an electromagnetic induction scheme according to an embodiment of the present disclosure.

As shown in FIG. 9, the operation states of the wireless power transmitter may be broadly divided into a standby state (STANDBY) 910, a signal detection state (PING) 920, an identification confirmation state (IDENTIFICATION) 930, a power transfer state (POWER TRANSFER) 940 and an end-of-charge state (END OF CHARGE) 950.

Referring to FIG. 9, during the standby state 910, the wireless power transmitter monitors the charging area to sense if a chargeable reception device is positioned in the charging area. The wireless power transmitter may monitor change in magnetic field, capacitance, or inductance to sense a chargeable reception device. When a chargeable reception device is found, the wireless power transmitter may transition from the standby state 910 to the signal detection state 920 (S912).

In the signal detection state 920, the wireless power transmitter may connect to the chargeable reception device and check if the reception device is using a valid wireless charging technique. In addition, in the signal detection state 220, the wireless power transmitter may perform an operation to distinguish other devices that generate dark current (parasitic current).

In the signal detection state 920, the wireless power transmitter may also send a digital ping having a structure according to a predetermined frequency and time to connect to a chargeable reception device. If a sufficient power signal is transferred from the wireless power transmitter to the wireless power receiver, the wireless power receiver may respond by modulating the power signal according to the protocol set in the electromagnetic induction scheme. If a valid signal according to the wireless charging technique used by the wireless power transmitter is received, the wireless power transmitter may transition from the signal detection state 920 to the identification confirmation state 930 without interrupting transmission of the power signal (S924). A wireless power transmitter that does not support the operation in the identification confirmation state 930 may transition to the power transfer state 940 (S924 and S934).

If the wireless power transmitter receives an end-of-charge signal from the wireless power receiver, the wireless power transmitter may transition from the signal detection state 920 to the end-of-charge state 950 (S926).

If no response from the wireless power receiver is sensed in the signal detection state 920, for example, if no feedback signal is received for a predetermined time, the wireless power transmitter may interrupt transmission of the power signal and transition to the standby state 910 (S922).

The identification confirmation state 930 may be selectively included depending on the wireless power transmitter.

Unique receiver identification information may be pre-allocated and maintained for each wireless power receiver. When a digital ping is sensed, the wireless power receiver needs to inform the wireless power transmitter that the corresponding device is chargeable according to a specific wireless charging technique. To check such receiver identification information, the wireless power receiver may transmit unique identification information thereof to the wireless power transmitter through feedback communication.

A wireless power transmitter supporting the identification confirmation state 930 may determine validity of the receiver identification information sent from the wireless power receiver. If it is determined that the received receiver identification information is valid, the wireless power transmitter may transition to the power transfer state 940 (S936). If the received receiver identification information is not valid or validity is not determined within a predetermined time, the wireless power transmitter may interrupt transmission of the power signal and transition to the standby state 910 (S932).

In the power transfer state 940, the wireless power transmitter may control the intensity of the transmit power based on the feedback signal received from the wireless power receiver. In addition, the wireless power transmitter in the power transfer state 940 may verify that there is no violation of an acceptable operation region and tolerance limit that may arise, for example, by detection of a new device.

If a predetermined end-of-charge signal is received from the wireless power receiver in the power transfer state 940, the wireless power transmitter may stop transmitting the power signal and transition to the end-of-charge state 950 (S946). In addition, if the internal temperature exceeds a predetermined value during operation in the power transfer state 940, the wireless power transmitter may interrupt transmission of the power signal and may transition to the end-of-charge state 950 (S944).

In addition, if a system error or the like is sensed in the power transfer state 940, the wireless power transmitter may stop transmitting the power signal and transition to the standby state 910 (S942). A new charging procedure may be resumed when a reception device to be charged is sensed in the charging area of the wireless power transmitter.

As described above, the wireless power transmitter may transition to the end-of-charge state 950 when the end-of-charge signal is input from the wireless power receiver or the temperature exceeds a predetermined range during operation.

If transition to the end-of-charge state 950 is caused by an end-of-charge signal, the wireless power transmitter may interrupt transmission of the power signal and wait for a certain time. Here, the certain time may vary depending on components such as coils provided in the wireless power transmitter, the range of the charging area, the allowable limit of the charging operation, or the like, in order to transmit the power signal in the electromagnetic induction scheme. After a certain time elapses in the end-of-charge state 950, the wireless power transmitter may transition to the signal detection state 920 to connect to the wireless power receiver positioned on the charging surface (S954). The wireless power transmitter may also monitor the charging surface for a certain time to recognize whether the wireless power reception device is removed. If it is sensed that the wireless power reception device has been removed from the charging surface, the wireless power transmission device may transition to the standby state 910 (S952).

If transition to the end-of-charge state S950 is performed due to the internal temperature of the wireless power transmitter, the wireless power transmitter may interrupt power transmission and monitor change in internal temperature. If the internal temperature falls within a certain range or to a certain value, the wireless power transmitter may transition to the signal detection state 920 (S954). The temperature range or value for transitioning the state of the wireless power transmitter may vary depending on the technology and method for manufacturing the wireless power transmitter. While monitoring change in temperature, the wireless power transmitter may monitor the charging surface to recognize if the wireless power reception device is removed. If it is sensed that the wireless power reception device has been removed from the charging surface, the wireless power transmitter may transition to the standby state 910 (S952).

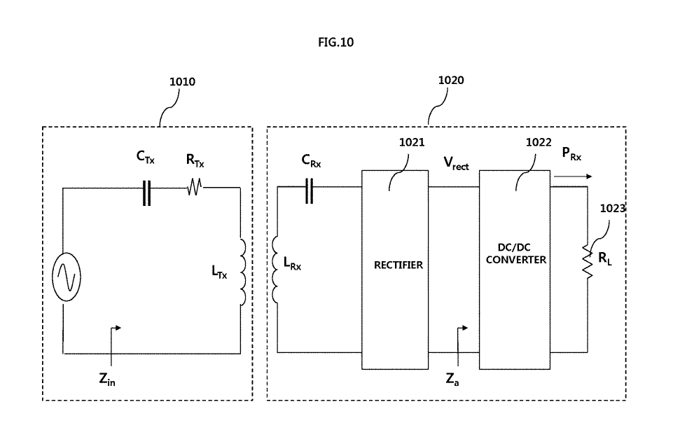

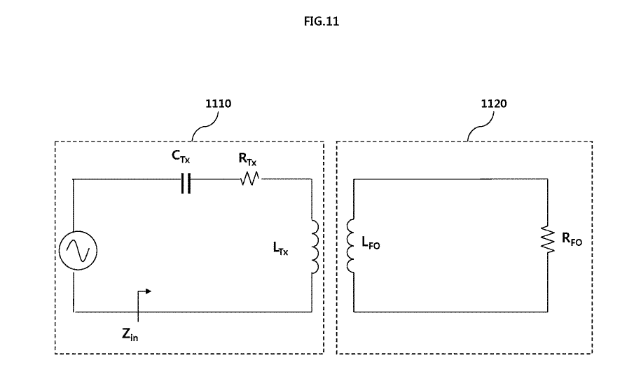

Hereinafter, a method and apparatus for identifying a wireless power receiver based on change in impedance due to power conversion in a wireless power transmitter will be described in detail with reference to FIGS. 10 to 15.

FIG. 10 is an equivalent circuit diagram of a wireless power transmission system for explaining an impedance calculation method for a normal wireless power receiver according to an embodiment of the present disclosure.

Referring to FIG. 10, the input impedance Zin at a wireless power transmitter 1010 may be calculated by Equation 1 given below when a wireless power receiver that is wirelessly chargeable is sensed.

$${Z}_{i n} = \frac{1}{j ω {C}_{tx}} + j ω {L}_{tx} + {R}_{tx} + \frac{{P}_{RX}}{{V}_{rect}^{2}} {ω}^{2} {k}^{2} {L}_{tx} {L}_{rx} \qquad Equation 1$$

Here, P_{RX} denotes the power applied to the load (R_{L}) 1023, V_{rect} denotes a voltage applied to a DC/DC converter 1022 as an output voltage of a rectifier 1021 of the wireless power receiver 1020, Cₜₓ denotes a capacitance value of the LC circuit of a wireless power transmitter 1010, R_{TX} denotes a resistance value of the wireless power transmitter 1010, L_{TX} denotes an inductance value of the LC circuit of the wireless power transmitter 1010, L_{Rx} denotes an inductance value of the LC circuit of the wireless power receiver 1020, C_{Rx} denotes a capacitance value of the LC circuit of the wireless power receiver 1020, and ω is 2f, where f denotes the operating frequency in the wireless power transmission system.

The impedance Zₐ in the wireless power receiver 1020 may be calculated by Equation 2 given below.

$${Z}_{a } = \frac{{V}_{rect}^{2}}{{P}_{Rx}} \qquad Equation 2$$

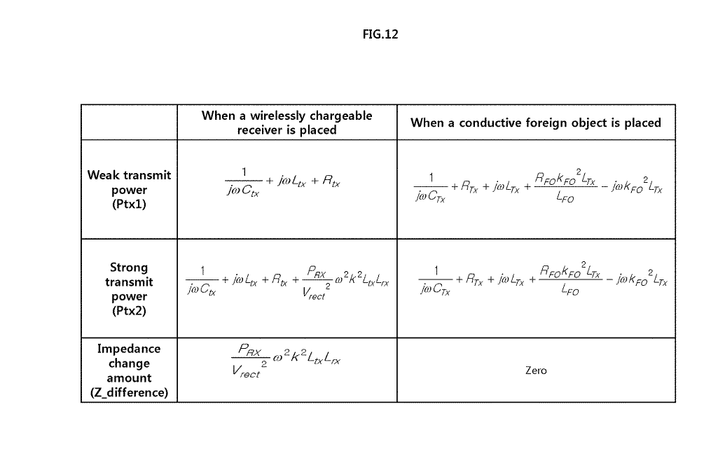

FIG. 11 is an equivalent circuit diagram of a wireless power transmission system for explaining an impedance calculation method for an object which cannot be wirelessly charged, according to an embodiment of the present disclosure.

Referring to FIG. 11, the equivalent circuit of a conductive object that may not be wirelessly charged (hereinafter referred to as a foreign object 1120 for simplicity) may be expressed as an RL equivalent circuit having an inductance value L_{FO} and a resistance value R_{FO}.

Here, the input impedance Zin at the wireless power transmitter 1110 may be calculated by Equation 3 given below.

$$\begin{matrix}{Z}_{i n} = \frac{1}{j ω {C}_{Tx }} + {R}_{Tx} + j ω {L}_{Tx} + \frac{{ω}^{2} {k}_{FO}^{2} {L}_{Tx} {L}_{FO}}{j ω {L}_{FO} + {R}_{FO}} \\ = \frac{1}{j ω {C}_{Tx}} + {R}_{Tx} + j ω {L}_{Tx} + \frac{( {R}_{FO} - j ω {L}_{FO} ) {ω}^{2} {k}_{FO}^{2} {L}_{Tx} {L}_{FO}}{{ω}^{2} {L}_{FO}^{2} + {R}_{FO }^{2}}\end{matrix} \qquad Equation 3$$

In Equation 3,

ω²L_{FO}²»R_{FO}².

Therefore, the input impedance may be approximated as Equation 4 below.

$${Z}_{i n} \approx \frac{1}{j ω {C}_{Tx}} + {R}_{Tx} + j ω {L}_{Tx} + \frac{( {R}_{FO} - j ω {L}_{FO} ) {ω}^{2} {k}_{FO}^{2} {L}_{Tx} {L}_{FO}}{{ω}^{2} {L}_{FO}^{2}} = \frac{1}{j ω {C}_{Tx}} + {R}_{Tx} + j ω {L}_{Tx} + \frac{{R}_{FO} {k}_{FO}^{2} {L}_{Tx}}{{L}_{FO}} - j ω {k}_{FO}^{2} {L}_{Tx} \qquad Equation 4$$

Referring to Equation 3, when the FO 1120 is placed in the charging area of the wireless power transmitter 1110, the wireless power transmitter 1110 has a constant impedance value regardless of the transmit power of the wireless power transmitter 1110. That is, the impedance value at the wireless power transmitter 1110 does not vary with the receive power at the FO 1120. On the other hand, the impedance value at the wireless power transmitter 1110 may vary with the value of P_{RX} at the normal wireless power receiver 1020 of FIG. 10 described above.

Thus, when the normal wireless power receiver 1020 is placed in the charging area, changing the intensity of the transmit power of the wireless power transmitter 1010 may change the intensity of the receive power of the wireless power receiver 1020, thereby varying the impedance value given at the power transmitter 1010.

According to one embodiment of the present disclosure, depending on whether the impedance of the transmission terminal is changed and/or the degree of change in impedance, the object placed in the charging area may be identified as an object that is wirelessly chargeable or a conductive object that is not wirelessly chargeable, i.e., FO.

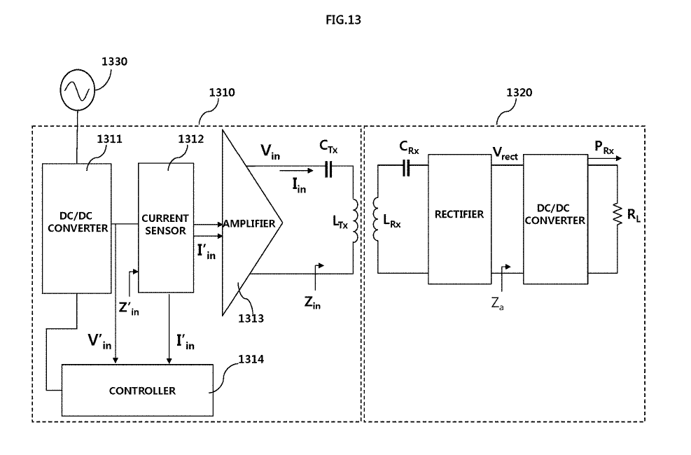

FIG. 12 shows a table for explaining change in impedance according to change in transmit power intensity according to an embodiment of the present disclosure.

Specifically, FIG. 12 shows transmitter impedance values measured for a weak transmit power Ptx_1 and a strong transmit power Ptx_2 transmitted by the wireless power transmitter when a normal wireless power receiver that is wirelessly chargeable (hereinafter referred to as a normal receiver for simplicity) or the FO is placed in a charging area.

As shown in FIG. 12, when the normal receiver is placed in the charging area, the impedance change amount Z_difference according to change in transmit power (from Ptx_1 to Ptx_2) may be calculated by Equation 5 given below.

$${Z}_{difference} = [ \frac{1}{j ω {C}_{tx}} + j ω {L}_{tx} + {R}_{tx} + \frac{{P}_{RX}}{{V}_{rect}^{2}} {ω}^{2} {k}^{2} {L}_{tx} {L}_{rx} ] - [ \frac{1}{j ω {C}_{tx} } + j ω {L}_{tx} + {R}_{tx} ] = \frac{{P}_{RX}}{{V}_{rect}^{2}} {ω}^{2} {k}^{2} {L}_{tx} {L}_{rx} \qquad Equation 5$$

On the other hand, when the FO is placed in the charging region, the impedance change amount Z_difference according to change in transmit power (from Ptx_1 to Ptx_2) may be calculated by Equation 6 given below.

$${Z}_{difference} = [ \frac{1}{j ω {C}_{Tx}} + {R}_{Tx} + j ω {L}_{Tx} + \frac{{R}_{FO} {k}_{FO}^{2} {L}_{Tx}}{{L}_{FO}} - j ω {k}_{FO}^{2} {L}_{Tx} ] - [ \frac{1}{j ω {C}_{Tx}} + {R}_{Tx} + j ω {L}_{Tx} + \frac{{R}_{FO} {k}_{FO}^{2} {L}_{Tx}}{{L}_{FO}} - j ω {k}_{FO}^{2} {L}_{Tx} ] = 0 \qquad Equation 6$$

For example, the Ptx_1 may be power so weak that a specific operating voltage cannot be output from the DC/DC converter of the wireless power receiver. On the other hand, Ptx_2 may be power strong enough to output the specific operating voltage from the DC/DC converter. In one example, the specific operating voltage may be a voltage required for operation of an electronic device on which the wireless power receiver is mounted. For example, for a smartphone, the operating voltage may be DC 5 V, but embodiments are not limited thereto.

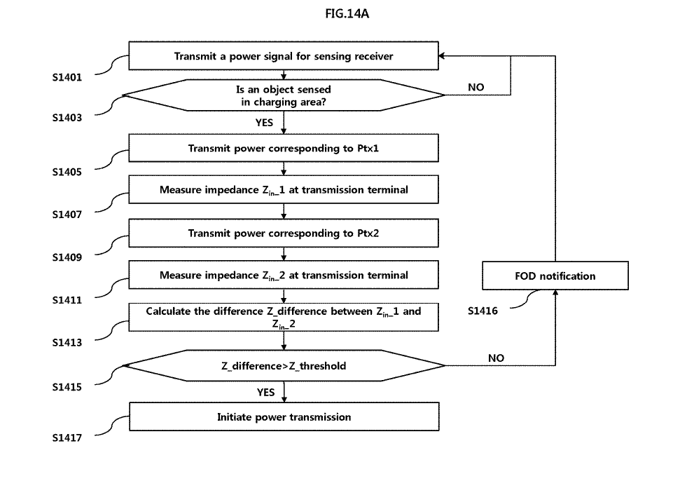

FIG. 13 is an equivalent circuit diagram for explaining a method for measuring impedance by a wireless power transmitter according to an embodiment of the present disclosure.

According to an embodiment of the present disclosure, the impedance may be measured by a wireless power transmitter 1310 at a stage after an amplifier 1313.

According to another embodiment of the present disclosure, the position at which impedance measurement is performed by the wireless power transmitter 1310 may be between a DC/DC converter 1311 and the amplifier 1313. The impedance value Zᵢₙ measured at a stage after the amplifier 1313 may be proportional to the impedance value Z′ᵢₙ measured at a stage before the amplifier 1313.

However, measuring the impedance at the stage after the amplifier 1313 may be inefficient in terms of cost and power loss.

Thus, it may be efficient to measure the current I′ᵢₙ and the voltage Vᵢₙ and calculate Z′ᵢₙ at a stage before the amplifier 1313, but embodiments are not limited thereto.

According to an embodiment of the present disclosure, the wireless power transmitter 1310 may include a current sensor 1312 for sensing the intensity of the output current of the DC/DC converter 1311.

In this case, the controller 1314 of the wireless power transmitter 1310 may calculate the intensity of the transmit power by acquiring the output voltage V′ᵢₙ of the DC/DC converter 1311 and the output current I′ᵢₙ sensed by the current sensor 1312. In addition, the controller 1314 may calculate the impedance Z′ᵢₙ at the stage before the amplifier 1313.

The controller 1314 may control the intensity of the output power by controlling the DC/DC converter 1311.

The controller 1314 may measure the amount of impedance change according to change in output power and determine whether the object placed in the charging area is a normal receiver, based on whether the measured impedance change amount exceeds a predetermined reference value.

In addition, the controller 1314 may identify the type or category of the normal receiver based on the measured impedance change amount.

The controller 1314 may control the intensity of power to be transmitted to the normal receiver according to the type or category of the identified receiver.

Although not shown in FIG. 13, the wireless power transmitter 1310 and the wireless power receiver 1320 may each further include a communication unit (not shown) for exchanging information.

In this case, the controller 1314 may adaptively control the transmit power intensity based on various state information received from the wireless power receiver 1320.

It should be noted that an AC/DC converter (not shown) may be additionally provided between a power source 1330 and the DC/DC converter 1311 when the power source 1330 provides an AC voltage in FIG. 13.

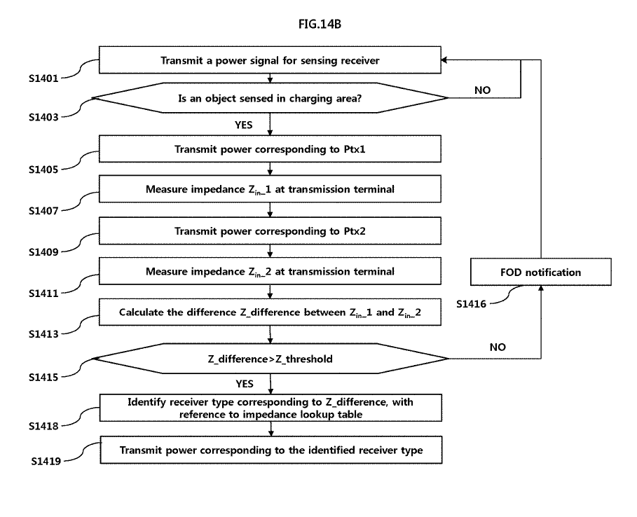

FIG. 14A is a flowchart illustrating a method for identifying a wireless power receiver by a wireless power transmitter according to an embodiment of the present disclosure.

Referring to FIG. 14A, the wireless power transmitter may transmit a predetermined power signal for sensing a receiver (S1401). Here, the power signal for sensing the receiver may be repeatedly transmitted at predetermined time intervals. At this time, it is noted that a power signal of a discrete foam having a predetermined periodicity may be transmitted during a repetition period, but embodiments are not limited thereto. It is noted that a continuous power signal may be transmitted during the repetition period. In one example, the power signal for sensing a receiver may be a beacon signal as defined in the A4WP standard or a ping signal as defined in the WPC or PMA standard, but embodiments are not limited thereto.

The wireless power transmitter may sense whether an object is placed in the charging area (S1403). For example, the wireless power transmitter may sense a change in intensity of the magnetic field transmitted through a transmission coil to determine whether an object is placed in the charged area. At this time, the change in intensity of the transmitted magnetic field may be sensed by a voltage sensor or a current sensor provided at one end of the transmission coil or the wireless power transmitter. If the sensed change in intensity of the magnetic field exceeds a predetermined reference value, the wireless power transmitter may determine that a conductive object is placed in the charging area. However, it should be noted that the wireless power transmitter cannot determine whether the conductive object is a normal receiver or an FO (Foreign Object) simply based on change in intensity of the magnetic field.

When an object is sensed, the wireless power transmitter may transmit power corresponding to predetermined Ptx_1 for a predetermined time (S1405), and measure the impedance Zᵢₙ_{_}1 at the transmission terminal at that time (S1407). Here, Zᵢₙ_{_}1 may be calculated as an average value of the impedance values measured at regular intervals for the predetermined time, but embodiments are not limited thereto.

Subsequently, the wireless power transmitter may transmit power corresponding to predetermined Ptx_2 for a predetermined time (S1409), and measure the impedance Zᵢₙ_{_}2 at the transmission terminal at that time (S1411). Here, Zᵢₙ_{_}2 may be calculated as an average value of the impedance values measured at regular intervals for the predetermined time, but embodiments are not limited thereto.

The wireless power transmitter may calculate the difference Z_difference between Zᵢₙ_{_}1 and Zᵢₙ_{_}2 (S1413), and determine whether Z_difference exceeds a predetermined impedance conversion threshold Z_threshold (S1415).

As a result of the determination, if the Z_difference exceeds Z_threshold, that is, if it is determined that the object is a normal receiver, the wireless power transmitter May initiate power transmission to the normal receiver (S1417).

If Z_difference does not exceed the Z_threshold in step 1415, that is, if it is determined that the object is an FO, the wireless power transmitter may output a notification indicating that the FO has been sensed, through a predetermined notification means including, for example, a display liquid crystal, an LED lamp, and a speaker (S1419), and return to step 1401 described above.

In the example of FIG. 14A according to an embodiment of the present disclosure, Ptx_1 and Ptx_2 may be set to pre-fixed values in the wireless power transmitter. For example, the value of Ptx_1 may be set such that a voltage applied to the load of the reception terminal, i.e., the output voltage of the DC/DC converter, is maintained to be lower than a specific predefined operating voltage (which may be DC 5V, which is an operating voltage of typical small electronic devices), and Ptx_2 may be set to be greater than Ptx_1 such that the voltage applied to the load may be maintained at the specific operating voltage.

In another example, Ptx_1 and Ptx_2 may be predetermined in correspondence to the class of the wireless power transmitter and/or the category of the wireless power receiver that may be supported with the wireless power transmitter.

In another example, Ptx_1 and Ptx_2 may be dynamically determined based on the degree of change in intensity of the magnetic field corresponding to a power signal for receiver sensing, which is generated when an object is placed in the charging area, wherein the object includes the normal receiver or FO. For example, the higher the degree of change in intensity of the magnetic field corresponding to the power signal for receiver sensing, the greater values Ptx_1 and Ptx_2 may be set to. In this case, the difference between Ptx_1 and Ptx_2 may also increase.

FIG. 14b is a flowchart illustrating a method for identifying a wireless power receiver by a wireless power transmitter according to an embodiment of the present disclosure.

As shown in FIG. 14B, if Z_difference exceeds Z_threshold (that is, it is determined that the object is a normal receiver) as a result of the determination in step 1415 of FIG. 14B, the wireless power transmitter may identify a receiver type or category corresponding to Z_difference, with reference to a pre-stored impedance lookup table (S1418).

The wireless power transmitter may transmit predefined power corresponding to the identified receiver type or category (S1419).

For steps 1401 to 1416 shown in FIG. 14B, refer to the description of the corresponding steps of FIG. 14A.

The wireless power transmitter according to an embodiment of the present disclosure may further perform a procedure of checking whether or not the communication unit for communication with the wireless power receiver operates normally before transmitting the power signal for receiver sensing. If the communication unit does not operate normally, the wireless power transmitter may perform the steps described in FIG. 14A or 14B described above.

According to another embodiment of the present disclosure, the wireless power transmitter may sense an object after sending a power signal for receiver sensing. Then, if communication connection with the sensed object is not normally established, the wireless power transmitter may perform the steps described in FIG. 14A or 14B described above. For example, the wireless power transmitter may perform the steps of FIG. 14A or FIG. 14B if communication connection with the object (receiver) is not normally established even though the object is sensed a predetermined number of times in the charging area. It should be noted that in this case, if it is already sensed that the object is placed in the charging area, steps 1401 to 1403 described in FIGS. 14A and 14B may be omitted.

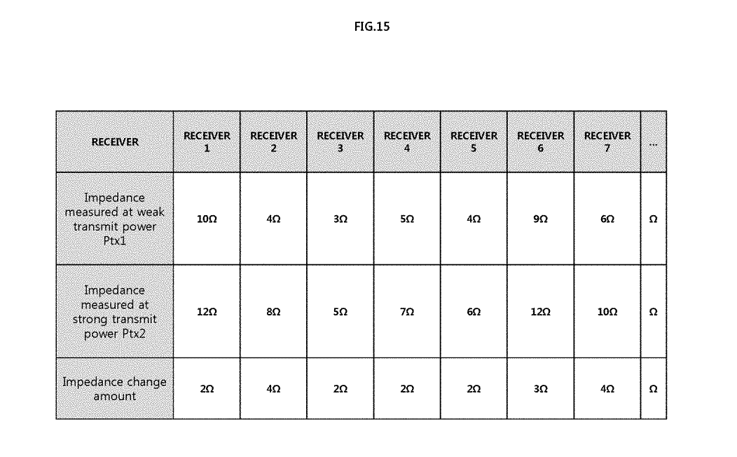

FIG. 15 illustrates the amount of change in impedance measured for each receiver according to an embodiment of the present disclosure.

Specifically, FIG. 15 illustrates that, for a normal receiver, the impedance values at weak transmit power Ptx_1 and strong transmit power Ptx_2 may differ from each other depending on the type of the receiver, and the corresponding impedance change amount Z_difference may also differ between the powers. It will be apparent to those skilled in the art that the impedance values shown in FIG. 15 are only one example for facilitating understanding of the present disclosure, other values may be obtained in actual implementation.

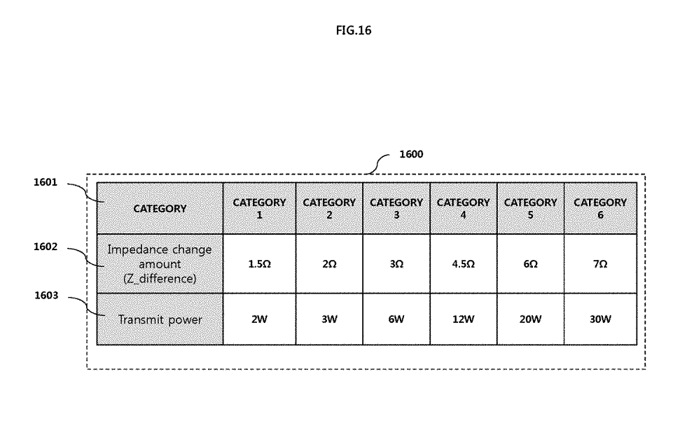

FIG. 16 is a category mapping table according to an embodiment of the present disclosure.

Referring to the category mapping table 1600 shown in FIG. 16, different categories 1601 may be mapped to the transmit powers according to the impedance change amount Z_difference 1602. The wireless power transmitter may also determine the intensity of a transmit power 1603 to be transmitted in correspondence with the identified category 1601 based on the measured impedance change amount 1602, with reference to the category mapping table 1600. It will be apparent to those skilled in the art that the category 1601 and the transmit power 1603 corresponding to the impedance change amount 1602 shown in FIG. 16 are only one embodiment for facilitating the understanding of the present disclosure, and actual implementation may be different from the illustrated embodiment.

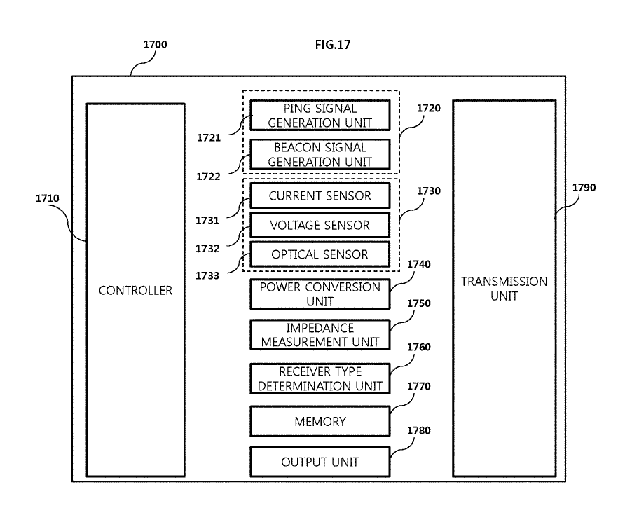

FIG. 17 is a block diagram illustrating the structure of a wireless power transmitter according to an embodiment of the present disclosure.

Referring to FIG. 17, a wireless power transmitter 1700 may include a controller 1710, a receiver sensing signal generation unit 1720, a sensing unit 1730, a power conversion unit 1740, an impedance measurement unit 1750, a receiver type determination unit 1760, a memory 1770, an output unit 1780, and a transmission unit 1790. It should be noted that the components of the wireless power transmitter 1700 of FIG. 17 described above are not essential, and thus the wireless power transmitter may be configured to include fewer or more components.

The controller 1710 may control the overall operation of the wireless power transmitter 1700.

The receiver sensing signal generation unit 1720 may generate a power signal of a predetermined pattern for sensing a receiver placed in the charging area and transmit the generated power signal to the transmission unit 1790.

The receiver sensing signal generation unit 1720 may include at least one of a ping signal generation unit 1721 for generating a ping signal based on the WPC and/or PMA standard or a beacon signal generation unit 1721 for generating a beacon signal based on the A4WP standard.

If the wireless power transmitter 1700 supports both the electromagnetic induction scheme and the electromagnetic resonance scheme, the ping signal and the beacon signal may be switched and transmitted at predetermined time intervals, but embodiments are not limited thereto. A wireless power transmitter 1700 according to another embodiment may transmit the ping signal and the beacon signal simultaneously.

The sensing portion 1730 may include at least one of a current sensor 1721/voltage sensor 1722 configured to sense the intensity of current or voltage at a specific terminal or specific position within the wireless power transmitter 1700 or an optical sensor 1723 configured to sense the intensity of the input light to determine whether an object is placed in the charging area. For example, the sensing unit 1730 may sense change in intensity of the magnetic field when a periodic power signal for sensing a receiver, for example, a ping signal and a beacon signal, is transmitted. It will be apparent to those skilled in the art that the change in intensity of the magnetic field at a specific position is correlated with change in current/voltage at that position. In another example, the sensing unit 1730 may measure the intensity of the output current and the output voltage of the DC/DC converter 1311 of FIG. 13 described above.

The power conversion unit 1740 may control the transmit power of the wireless power transmitter 1700 under control of the controller 1710. For example, the power conversion unit 1740 may set first to n-th transmit powers for measuring the impedance change amount Z_difference under control of the controller 1710 (wherein n is a natural number greater than or equal to 2). In another example, the power converter 1740 may set transmit power corresponding to a category identified according to the impedance change amount measured in accordance with the control signal of the controller 1710. In addition, the power conversion unit 1740 may adaptively control the intensity of the transmit power based on the state information about the wireless power receiver received during wireless power transmission.

The impedance measurement unit 1750 may function to measure impedance at a specific terminal and/or specific position according to the control signal of the controller 1710 and to calculate the amount of change in impedance between different transmit powers.

The receiver type determination unit 1760 may function to determine whether an object sensed in the charging area is a normal receiver by comparing the impedance change amount Z_difference calculated by the impedance measurement unit 1750 with a predetermined impedance change amount threshold Z_threshold and to identify the type/kind/category/characteristics of the receiver based on the impedance change amount for the normal receiver.

The memory 1770 may not only record a program for controlling the overall operation of the wireless power transmitter 1700, but also maintain various data, tables, and the like necessary for execution of the program. For example, the category mapping table 1600 according to the above-described amount of change in impedance of FIG. 16 may be recorded in the memory 1770. In another example, a predetermined announcement message indicating that the FO in FIG. 14 has been sensed may be recorded in the memory 1770.

The output unit 1780 may provide various output means for outputting operational state information about the wireless power transmitter 1700 and various notification messages. For example, the output means may include, but is not limited to, a liquid crystal display, an LED lamp, and a speaker.

The transmission unit 1790 may function to transmit a periodic power signal for sensing an object in the charging area and to transmit a power signal of a predetermined strength to a normal receiver when the normal receiver is sensed.

In one embodiment of the present disclosure, two first and second transmit power intensities for the transmission terminal to measure an impedance change amount may be set. In this case, the controller 1710 may set the first transmit power intensity such that the voltage applied to the reception terminal load is kept below a specific operating voltage, and may set the second transmit power intensity such that such that the voltage applied to the reception terminal load is maintained at the specific operating voltage.

In another example, the controller 1710 may set the first transmit power intensity and the second transmit power intensity based on the class of the wireless power transmitter 1700.

In another example, the controller 1710 may set the first transmit power intensity and the second transmit power intensity further based on categories of supportable wireless power receivers according to the class of the wireless power transmitter.

In another example, the controller 1710 may dynamically set the first transmit power intensity and the second transmit power intensity based on the degree of change in intensity of the magnetic field corresponding to a power signal transmitted to sense an object in the charging area.

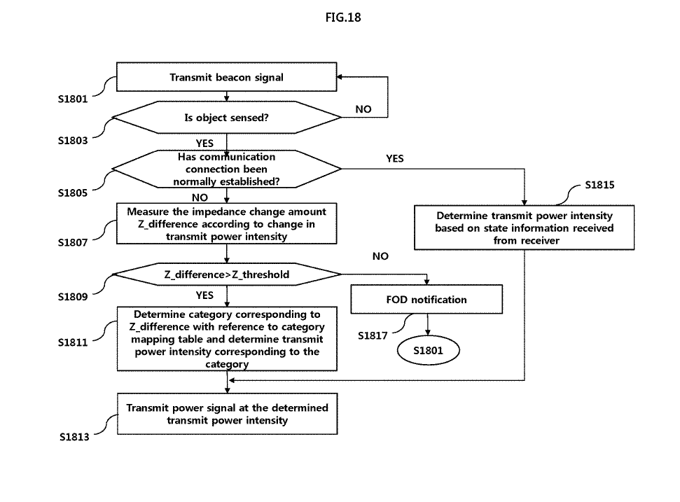

FIG. 18 is a flowchart illustrating a method for identifying a wireless power receiver by a wireless power transmitter supporting an electromagnetic resonance scheme according to an embodiment of the present disclosure.

Referring to FIG. 18, the wireless power transmitter may transmit a beacon signal for identifying a receiver (S1801).

When an object is sensed in the charging area, the wireless power transmitter may attempt to establish communication connection with the sensed object through exchange of a predetermined control signal at an out-of-band communication frequency.

Then, the wireless power transmitter may determine whether the communication connection with the sensed object has been normally established (S1805).

If communication connection with the sensed object has not been normally established, the wireless power transmitter may initiate the procedure of measuring the impedance change amount Z_difference according to change in transmit power intensity (S1807).

The wireless power transmitter may determine whether Z_difference exceeds a predetermined impedance conversion threshold Z_threshold (S1809).

As a result of the determination, if the Z_difference exceeds Z_threshold, that is, if it is determined that the object is a normal receiver, the wireless power transmitter may identify a category corresponding to Z_difference with reference to the pre-stored category mapping table 1600, and determine a transmit power intensity corresponding to the identified category (S1811).

The wireless power transmitter may transmit a power signal at the determined transmit power intensity (S1813).

In step 1805, if communication connection with the sensed object is normally established, the wireless power transmitter may exchange state information with the wireless power receiver on an out-of-band communication channel.

The wireless power transmitter may determine the transmit power intensity based on the state information received from the wireless power receiver (S1815).

In step 1809, if the Z_difference does not exceed the Z_threshold, that is, if it is determined that the object is an FO, the wireless power transmitter may output a notification indicating that the FO has been sensed, through a predetermined notification means including, for example, a liquid crystal display, an LED lamp, and a speaker (S1817), and return to step 1401 described above.

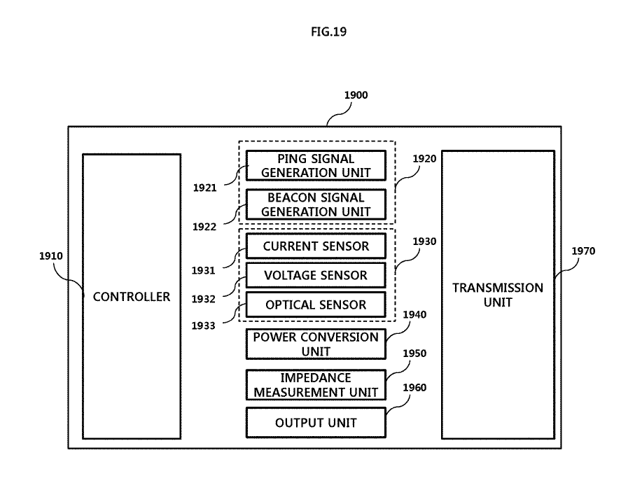

FIG. 19 is a block diagram illustrating the structure of a wireless power transmitter according to another embodiment of the present disclosure.

Referring to FIG. 19, a wireless power transmitter 1900 may include a controller 1910, a receiver sensing signal generation unit 1920, a sensing unit 1930, a power conversion unit 1940, an impedance measurement unit 1950, an output unit 1960, and a transmission unit 1970. It should be noted that the components of the wireless power transmitter 1900 of FIG. 19 described above are not essential, and thus the wireless power transmitter may be configured to include fewer or more components.

The controller 1910 may control the overall operation of the wireless power transmitter 1900.

The receiver sensing signal generation unit 1920 may generate a power signal of a predetermined pattern for sensing a receiver placed in the charging area and transmit the generated power signal to the transmission unit 1970.

The receiver sensing signal generation unit 1920 may include at least one of a ping signal generation unit 1921 for generating a ping signal based on the WPC and/or PMA standard or a beacon signal generation unit 1921 for generating a beacon signal based on the A4WP standard.

If the wireless power transmitter 1900 supports both the electromagnetic induction scheme and the electromagnetic resonance scheme, the ping signal and the beacon signal may be switched and transmitted at predetermined time intervals, but embodiments are not limited thereto. A wireless power transmitter 1900 according to another embodiment may transmit the ping signal and the beacon signal simultaneously.

The sensing portion 1930 may include at least one of a current sensor 1921/voltage sensor 1922 configured to sense the intensity of current or voltage at a specific terminal or specific position within the wireless power transmitter 1900 or an optical sensor 1923 configured to sense the intensity of the input light to determine whether an object is placed in the charging area. For example, the sensing unit 1930 may sense change in intensity of the magnetic field when a power signal for sensing a receiver, for example, a ping signal and a beacon signal, is transmitted. It will be apparent to those skilled in the art that the change in intensity of the magnetic field at a specific position is correlated with change in current/voltage at that position. In another example, the sensing unit 1530 may measure the intensity of the output current and the output voltage of the DC/DC converter 1311 of FIG. 13 described above.

The power conversion unit 1940 may function to change the transmit power intensity of the wireless power transmitter 1900 under control of the controller 1910. For example, the power conversion unit 1940 may set intensities of first to n-th transmit powers for measuring the impedance change amount Z_difference under control of the controller 1910 (wherein n is a natural number greater than or equal to 2). In addition, the power conversion unit 1940 may adaptively control the intensity of the transmit power based on the state information about the wireless power receiver received during wireless power transmission.

The impedance measurement unit 1950 may function to measure impedance at a specific terminal and/or specific position according to the control signal of the controller 1910 and to calculate the amount of change in impedance according to change in transmit power intensity.

The output unit 1980 may provide various output means for outputting operational state information about the wireless power transmitter 1900 and various notification messages. For example, the output means may include, but is not limited to, a liquid crystal display, an LED lamp, and a speaker.

The transmission unit 1970 may function to wirelessly transmit a power signal for a normal receiver.

In one embodiment of the present disclosure, two first and second transmit power intensities for the transmission terminal to measure an impedance change amount may be set. In this case, the controller 1910 may set the first transmit power intensity such that the voltage applied to the reception terminal load is kept below a specific operating voltage, and may set the second transmit power intensity such that such that the voltage applied to the reception terminal load is maintained at the specific operating voltage.

In another example, the controller 1910 may set the first transmit power intensity and the second transmit power intensity based on the class of the wireless power transmitter 1900.

In another example, the controller 1910 may set the first transmit power intensity and the second transmit power intensity further based on categories of supportable wireless power receivers according to the class of the wireless power transmitter.

In another example, the controller 1910 may dynamically set the first transmit power intensity and the second transmit power intensity based on the degree of change in intensity of the magnetic field corresponding to a power signal transmitted to sense an object in the charging area.

Another embodiment of the present disclosure may provide a computer-readable recording medium on which a program for executing the methods for identifying a wireless power receiver by the wireless power transmitter described above is recorded.

In this case, the computer-readable recording medium may be distributed to a computer system connected over a network, and computer-readable code may be stored and executed thereon in a distributed manner. Functional programs, code, and code segments for implementing the method described above may be easily inferred by programmers in the art to which the embodiments pertain.

It is apparent to those skilled in the art that the present disclosure may be embodied in specific forms other than those set forth herein without departing from the spirit and essential characteristics of the present disclosure.

Therefore, the above embodiments should be construed in all aspects as illustrative and not restrictive. The scope of the disclosure should be determined by the appended claims and their legal equivalents, and all changes coming within the meaning and equivalency range of the appended claims are intended to be embraced therein.

### INDUSTRIAL APPLICABILITY

The present disclosure relates to a wireless charging technique and may be applied to a wireless power transmission apparatus that wirelessly transmits power.

1. A method for identifying a wireless power receiver by a wireless power transmitter, the method comprising:
sensing an object in a charging area;
calculating an impedance change amount according to change in transmit power intensity when the object in the charging area is sensed;
determining whether the object is a normal receiver based on the impedance change amount; and
when it is determined that the object is the normal receiver, starting transmission of wireless power to the normal receiver.

2. The method according to claim 1, wherein the calculating of the impedance change amount comprises:
calculating a first impedance corresponding to a first transmit power intensity;
calculating a second impedance corresponding to a second transmit power intensity; and
calculating a difference between the first impedance and the second impedance.

3. The method according to claim 2, wherein the first transmit power intensity is set such that a voltage applied to a load is maintained to be lower than or equal to a specific operating voltage, and the second transmit power intensity is set such that the voltage applied to the load is maintained to be the specific operating voltage.

4. The method according to claim 2, wherein the first transmit power intensity and the second transmit power intensity are set based on a class of the wireless power transmitter.

5. The method according to claim 4, wherein the first transmit power intensity and the second transmit power intensity are set further based on a category of a wireless power receiver supportable according to the class of the wireless power transmitter.

6. The method according to claim 2, wherein the first transmit power intensity and the second transmit power intensity are set based on a degree of change in intensity of a magnetic field corresponding to a power signal transmitted to sense the object in the charging area.

7. The method according to claim 1, wherein, when the impedance change amount exceeds a predetermined reference value, it is determined that the sensed object is the normal receiver.

8. The method according to claim 1, wherein, when the impedance change amount is 0 or less than or equal to a predetermined reference value, it is determined that the sensed object is not the normal receiver,
the method further comprising:
when it is determined that the sensed object is not the normal receiver, indicating that a foreign object (FO) has been sensed.

9. The method according to claim 1, wherein the sensing of the object in the charging area comprises:
transmitting a periodic power signal for sensing the object;
sensing change in the transmitted power signal; and
sensing whether the object is placed in the charging area according to the sensed change in the power signal.

10. The method according to claim 9, wherein the periodic power signal comprises at least one of a ping signal or a beacon signal.

11. An apparatus for identifying a wireless power receiver, comprising:
a sensing unit configured to sense an object in a charging area;
an impedance measurement unit configured to calculate an impedance change amount according to change in transmit power intensity when the object is sensed;
a controller configured to determine whether the object is a normal receiver based on the impedance change amount; and
a transmitter configured to transmit a power signal to the normal receiver under control of the controller.

12. The apparatus according to claim 11, wherein the impedance measurement unit measures a first impedance corresponding to a first transmit power intensity and a second impedance corresponding to a second transmit power intensity, and determines a difference between the first impedance and the second impedance as the impedance change amount.

13. The apparatus according to claim 12, wherein the controller determines that the sensed object is the normal receiver when the impedance change amount exceeds a predetermined reference value, and determines that the sensed object is a foreign object (FO) when the impedance change amount is less than or equal to the reference value or is 0.

14. The apparatus according to claim 12, wherein the first transmit power intensity is set such that a voltage applied to a load is maintained to be lower than or equal to a specific operating voltage, and the second transmit power intensity is set such that the voltage applied to the load is maintained to be the specific operating voltage.

15. The apparatus according to claim 12, wherein the first transmit power intensity and the second transmit power intensity are set based on a class of the wireless power transmitter.

16. The apparatus according to claim 15, wherein the first transmit power intensity and the second transmit power intensity are set further based on a category of a wireless power receiver supportable according to the class of the wireless power transmitter.

17. The apparatus according to claim 12, wherein the first transmit power intensity and the second transmit power intensity are set based on a degree of change in intensity of a magnetic field corresponding to a power signal transmitted to sense the object in the charging area.

18. The apparatus according to claim 13, further comprising:
an output unit configured to display, when it is determined that the object is not the normal receiver, a predetermined notification message indicating that the FO has been sensed.

19. The apparatus according to claim 11, further comprising:
a receiver sensing signal generation unit configured to transmit a periodic power signal for sensing the object,
wherein the sensing unit senses whether the object is placed in the charging area based on change in intensity of a magnetic field corresponding to the transmitted periodic power signal.

20. The apparatus according to claim 19, wherein the periodic power signal comprises at least one of a ping signal or a beacon signal.
